(19) United States
(12) Patent Application Publication
(10) Pub. No.: US 2008/0109478 A1
(43) Pub. Date: May 8, 2008

(54) Digital-content retrieval apparatus, digital-content retrieval method, and computer product

(75) Inventors: Yuji Wada, Kawasaki (JP); Takao Mohri, Kawasaki (JP); Satoru Chikuma, Kawasaki (JP)

Correspondence Address: STAAS & HALSEY LLP, SUITE 700, 1201 NEW YORK AVENUE, N.W., WASHINGTON, DC, 20005, US

(73) Assignee: Fujitsu Limited, Kawasaki (JP)

(21) Appl. No.: 11/896,107

(22) Filed: Aug. 29, 2007

(30) Foreign Application Priority Data
Nov. 2, 2006 (JP) 2006-299541

(51) Int. Cl. G06F 17/30

(52) U.S. Cl. 707/103 Y; 707/E17.055

(57) ABSTRACT

A collective retrieval function of a DMC (or DMP) device requests a DMS device having a “sufficient search capability” to conduct retrieval using a retrieval function provided in the DMS device, whereas the DMC (or DMP) conducts retrieval from a DMS device not having the “sufficient search capability” by using “retrieval-by-index” in place of retrieval performed by the DMS device. Thus, because requests for retrieval and retrieval-by-index are actively switched according to whether the DMS device to be subjected to the collective retrieval has the “sufficient search capability”, it is possible to conduct collective retrieval irrespective of whether the DMS device has the “sufficient retrieval capability”.

### BACKGROUND OF THE INVENTION

1. Field of the Invention

The present invention relates to a technology for collectively retrieving a digital content that satisfies a specified retrieval criterion from a plurality of digital content storage devices each connected to a network.

2. Description of the Related Art

In recent years, digital home products, such as an image storage device that stores images in the form of digital data and a digital music terminal that stores sound in the form of digital data. These digital home products are connected to a home network based on a base technology and protocols of Digital Living Network Alliance (DLNA) and Universal Plug and Play (UPnP) in a similar manner of conventional computer equipment, thereby making it possible to share digital contents held by the products and the equipment.

To enhance the usefulness of a home network configured as described above, it is important that a user can easily find a desired digital product so that the user can reproduce it among digital contents distributed in the digital home products.

To satisfy such a demand, for example, “DIXIM2—Multimedia Home Network Kit (Online, 2006, product introduction, [searched on Nov. 2, 2006], Internet <URL:http://www.dixim.net/pu/pro/dx2/index.html>)” discloses a collective retrieval system that displays a result of collective retrieval of a digital content from a plurality of digital home products connected to a home network so that a user can easily find a digital home product that contains a desired digital to thereby allow the user easy access to the digital content.

Although the conventional technique typified by “DIXIM2—Multimedia Home Network Kit” is premised that a digital home product corresponding to a digital media server (DMS) device in DLNA has an information retrieval function, DLNA does not make it an essential requirement for a DMS device to have the information retrieval function. Hence, because some DMS devices do not have the information retrieval function, the conventional technique typified by “DIXIM2—Multimedia Home Network Kit” has failed to include such a device not having the information retrieval function into DMS devices from which a digital content is to be retrieved.

The conventional technique typified by “DIXIM2—Multimedia Home Network Kit” has also failed to include a DMS device that has the information retrieval function but does not have a necessary search attribute into DMS devices from which a digital content is to be retrieved in to response to a retrieval request from the collective retrieval system. When an interface of the digital home product to be subjected to the retrieval is flexibly extensible, the problem can be solved by, for example, rewriting control software to extend the interface to thereby add an information retrieval function to the product or cause the product to support a necessary search attribute. However, extending an interface of a digital home product by, e.g., rewriting control software, is impractical.

Recent progress of digital home products into mobile terminals has made it possible to carry such a product freely. Accordingly, circumstances under which a digital home product is brought into a home network and connected thereto freely are increased in frequency, which disturbs stability in DMS device connection to the home network and makes the network more variable. This means that the number of DMS devices newly detected in the home network has been increased.

When the DMS device connected to a home network is a mobile terminal, the powerless processing capability of the mobile terminal per se, restrictions imposed by being battery-powered, and the like, requires more speedy retrieval of a digital content from the product. However, the conventional technique typified by “DIXIM2—Multimedia Home Network Kit” has failed to attain speedy search of a digital content in a condition in which a DMS device is freely connected to a home network.

While the progress of DMS devices into mobile terminals has made DMS devices to be freely connected to a home network, when such a DMS device does not have an information retrieval function or a necessary search attribute, the DMS device cannot respond to a retrieval request from a collective retrieval system. This means that the DMS device fails to make full use of an advantage of being a mobile terminal.

### SUMMARY OF THE INVENTION

It is an object of the present invention to at least partially solve the problems in the conventional technology.

According to an aspect of the present invention, a computer-readable recording medium that stores therein a computer program that causes a computer to execute a digital-content retrieval procedure for collectively retrieving a digital content satisfying a specified retrieval criterion from a plurality of digital-content storage devices connected to a network. Specifically, the computer program causes the computer to execute determining whether each of the digital-content storage devices has a search capability; and collective retrieving including when one or more of the digital-content storage devices are determined to have the search capability at the determining, requesting each of the devices to retrieve the digital content using a retrieval function provided in the digital-content storage device, and when one or more of the digital-content storage devices are determined not to have the search capability at the determining, fetching content information on a digital content stored in each of the devices using a browsing function provided in the digital-content storage device.

According to another aspect of the present invention, a computer-readable recording medium that stores therein a computer program that causes a computer to execute a digital-content retrieval procedure for collectively retrieving a digital content satisfying a specified retrieval criterion from a plurality of digital-content storage devices connected to a network. Specifically, the computer program causes the computer to execute determining whether each of the digital-content storage devices has a search capability; creating and storing an index of a digital content stored in each of the devices when one or more of the digital digital-content storage devices determined not to have the search capability at the determining; and collective retrieving including when one or more of the digital-content storage devices are determined to have the search capability at the determining, requesting each of the devices to retrieve the digital content using a retrieval function provided in the digital-content storage device, and retrieving, from each of the digital-content storage devices determined not to have the search capability at the determining, the digital content by utilizing the index created at the creating and storing.

According to still another aspect of the present invention, a digital-content retrieval apparatus that collectively retrieves a digital content satisfying a specified retrieval criterion from a plurality of digital-content storage devices connected to a network, includes a search-capability determining unit that determines whether each of the digital-content storage devices has a search capability; and a collective-retrieval executing unit that when one or more of the digital-content storage devices are determined to have the search capability by the search-capability determining unit, requests each of the devices to retrieve the digital content using a retrieval function provided in the digital-content storage device, and when one or more of the digital-content storage devices are determined not to have the search capability by the search-capability determining unit, fetches content information on a digital content stored in each of the devices using a browsing function provided in the digital-content storage device.

According to still another aspect of the present invention, a digital-content retrieval apparatus that collectively retrieves a digital content satisfying a specified retrieval criterion from a plurality of digital-content storage devices connected to a network, includes a search-capability determining unit that determines whether each of the digital-content storage devices has a search capability; a creating-and-storing unit that creates and stores an index of a digital content stored in each of the devices when one or more of the digital digital-content storage devices determined not to have the search capability by the search-capability determining unit; and a collective-retrieval executing unit that when one or more of the digital-content storage devices are determined to have the search capability by the search-capability determining unit, requests each of the devices to retrieve the digital content using a retrieval function provided in the digital-content storage device, and retrieves, from each of the digital-content storage devices determined not to have the search capability by the search-capability determining unit, the digital content by utilizing the index created by the creating-and-storing unit.

According to still another aspect of the present invention, a digital-content retrieval method for collectively retrieving a digital content satisfying a specified retrieval criterion from a plurality of digital-content storage devices connected to a network, includes determining whether each of the digital-content storage devices has a search capability; and collective retrieving including when one or more of the digital-content storage devices are determined to have the search capability at the determining, requesting each of the devices to retrieve the digital content using a retrieval function provided in the digital-content storage device, and when one or more of the digital-content storage devices are determined not to have the search capability at the determining, fetching content information on a digital content stored in each of the devices using a browsing function provided in the digital-content storage device.

According to still another aspect of the present invention, a digital-content retrieval method for collectively retrieving a digital content satisfying a specified retrieval criterion from a plurality of digital-content storage devices connected to a network, includes determining whether each of the digital-content storage devices has a search capability; creating and storing an index of a digital content stored in each of the devices when one or more of the digital digital-content storage devices determined not to have the search capability at the determining; and collective retrieving including when one or more of the digital-content storage devices are determined to have the search capability at the determining, requesting each of the devices to retrieve the digital content using a retrieval function provided in the digital-content storage device, and retrieving, from each of the digital-content storage devices determined not to have the search capability at the determining, the digital content by utilizing the index created at the creating and storing.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a schematic diagram for explaining a problem of a conventional technique;

FIG. 2 is a schematic diagram for explaining features of the present invention;

FIG. 3 depicts a DLNA network configuration;

FIG. 4 is a functional block diagram of a configuration of a digital-content retrieval apparatus;

FIG. 5 is an example of DMS information;

FIG. 6 is an example of necessary search attributes;

FIG. 7 is an example of indexes;

FIG. 8 is an example of a user profile;

FIG. 9 is an example of a DMS history;

FIG. 10 is an example of a DMS-name correspondence table;

FIG. 11 is an example of a container-name correspondence table;

FIG. 12 depicts a container structure of a DMS device;

FIG. 13 is a time chart of processes at startup of the digital-content retrieval apparatus;

FIG. 14 is a time chart of processes performed when the DMS device (with DMS information thereon unregistered) is newly detected;

FIG. 15 is a time chart of processes performed when the DMS device (with DMS information thereon registered) is newly detected;

FIG. 16 is a time chart of processes performed when the DMS device (with DMS information thereon unregistered) is leaving;

FIG. 17 is a time chart of processes performed when the DMS device (with DMS information thereon registered) is leaving;

FIG. 18 is a time chart of processes performed at the time of updating the DMS device;

FIG. 19 is a time chart of collective retrieval;

FIG. 20 is a time chart of processes performed by the digital-content retrieval apparatus when the power therefor is shut down;

FIG. 21 is a time chart of processes at the time of determining search capability of the DMS device;

FIG. 22 is a time chart of processes at the time of creating an index (first);

FIG. 23 is a time chart of processes at the time of creating an index (second);

FIG. 24 is a time chart of processes at the time of updating an index (first);

FIG. 25 is a time chart of processes at the time of updating an index (second);

FIG. 26 is a time chart of processes at the time of selecting a DMS device;

FIG. 27 is a time chart of processes at the time of selecting a container; and

FIG. 28 is a time chart of processes at time of collective retrieval.

### DETAILED DESCRIPTION OF THE PREFERRED EMBODIMENTS

Exemplary embodiments of a digital-content retrieval program, a digital-content retrieval apparatus, and a digital-content retrieval method according to the present invention will be explained below in detail with reference to the accompanying drawings. The following embodiments will be explained based on a DLNA configuration, in which the digital-content retrieval apparatus is included in a digital media controller (DMC) device that receives an operating instruction from the user and outputs an operating signal to a device to be operated. However, the configuration is not limited thereto. In an alternative configuration, the digital-content retrieval apparatus can be included in a digital media player (DMP) device that reproduces a digital content. Furthermore, when the DMC device and the DMP device are integrated in one unit, the digital-content retrieval apparatus can be included therein. Moreover, the digital-content retrieval apparatus can be independent from both the DMC device and the DMP device.

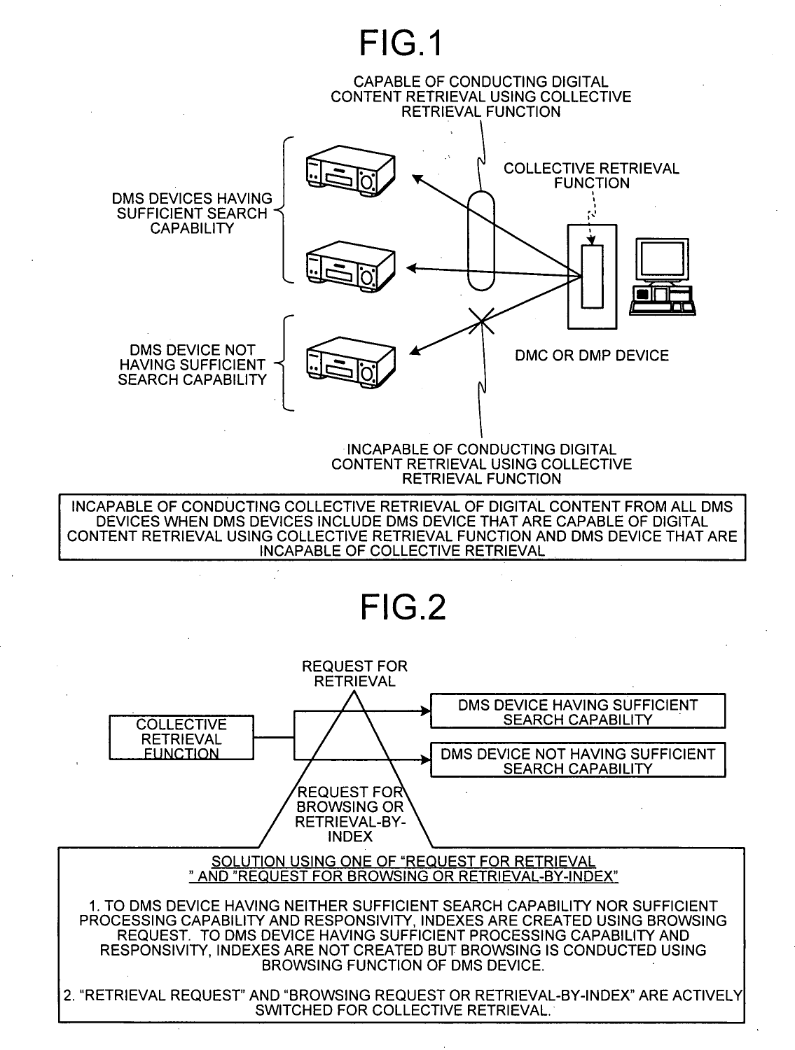

Prior to explanations of the embodiments, a problem of the conventional technique and features of the present invention will be explained with reference to FIGS. 1 and 2. FIG. 1 is a schematic diagram for explaining the problem of the conventional technique. As shown in FIG. 1, a plurality of DMS devices (hard disk recorders are assumed in FIG. 1) and a DMC or DMP device are connected through a home network (hereinafter, “network”). One or more digital contents are stored in each of the DMS devices.

The DMS devices include one or more DMS devices each having a “sufficient search capability” and one or more DMS devices each not having the “sufficient search capability”. When a DMS device has the “sufficient search capability”, the DMS device has a “retrieval function” specified by the DLNA guidelines and supports a search attribute that is necessary for retrieval using the “retrieval function”. The term “sufficient” is appended to indicate that the DMS device supports the search attribute necessary for the retrieval based on the “retrieval function”.

The “retrieval function” is a function specified by the DLNA guidelines that allows a DMS device, when a retrieval request is transmitted from a DMC device to the DMS device together with a retrieval criterion, to return a digital content satisfying the retrieval criterion among digital contents held by the DMS device. The “retrieval function” is not a requisite function of a DMS device according to the guidelines.

In contrast, a “browsing function” is a requisite function according to the DLNA guidelines. The “browsing function” is a function that allows a DMS device to sequentially browse digital contents held in the DMS device in a tree structure from a root container. For example, by appending to a browsing request issued to a DMS device an optional request of “BrowseMetadata” and a container ID to be browsed, meta data pertaining to the container can be fetched from the DMS device. Alternatively, by appending to a browsing request to a DMS device an optional request of “BrowseDirectChildren” and a container ID to be browsed, attribute information about containers of child nodes of the designated container or a digital content in the designated container can be fetched from the DMS device.

As shown in FIG. 1, an example in which a DMC (or DMP) device has a function of collectively retrieving a digital content, and conducts collective retrieval of a digital content from a plurality of DMS devices is assumed. While retrieval of a digital content from a DMS device having the “sufficient search capability” is attained using the collective retrieval function, retrieval from a DMS device not having the “sufficient search capability” cannot be attained using the function. Thus, the conventional technique has failed to conduct collective retrieval of a digital content from DMS devices when the DMS devices include one or more DMS devices having the “sufficient search capability” and one or more DMS devices not having the “sufficient search capability”.

To this end, as shown in FIG. 2, in the present invention, a collective retrieval function of a DMC (or DMP) device requests a DMS device having the “sufficient search capability” to conduct retrieval using the retrieval function of the DMS device, while conducting retrieval from a DMS device having neither the “sufficient search capability”, nor a sufficient processing capability and responsivity using “retrieval-by-index” in place of retrieval performed by the DMS device. The “retrieval-by-index” is a retrieval method of, in place of retrieval performed by the DMS device per se, retrieving a digital content from a DMS device not having the “sufficient search capability” using “indexes” created by a browsing request. This function is inevitably provided in each DMS device according to the DLNA guidelines. Meanwhile, as for a DMS device not having the “sufficient search capability” but having a sufficient processing capability and responsivity, content information on digital contents held by the DMS device is browsed using a browsing function provided in the DMS device.

As described above, the present invention actively switches between a request-for-retrieval and either one of request-for-retrieval and “retrieval-by-index” according to whether each DMS device to be subjected to collective retrieval has the “sufficient retrieval capability” and whether the DMS device has the sufficient processing capability and responsivity. Hence, the present invention allows to conduct collective retrieval irrespective of whether a DMS device to be subjected to the retrieval has the “sufficient retrieval capability” and whether the DMS device has the sufficient processing capability and responsivity.

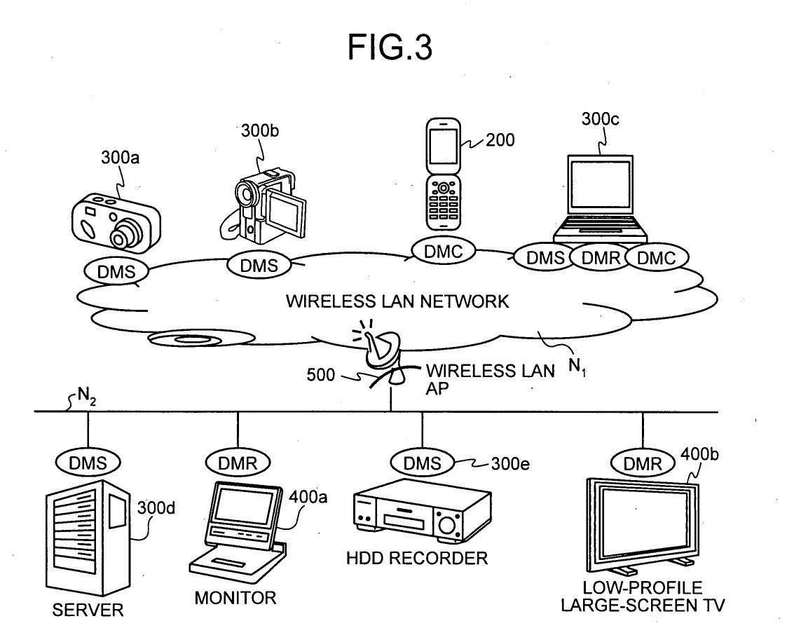

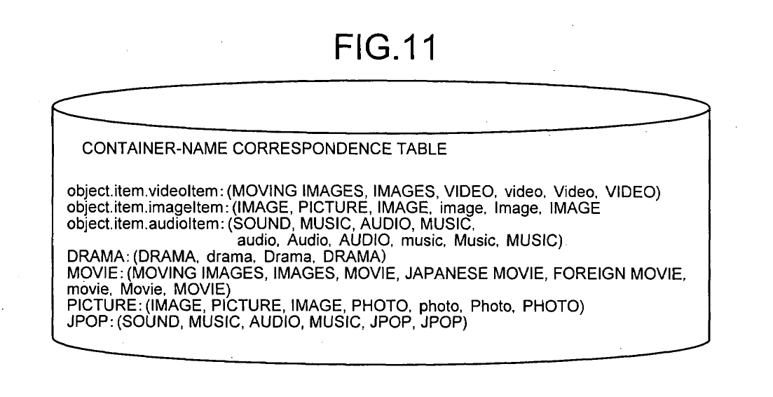

With reference to FIGS. 3 to 28, embodiments of the present invention will be explained below in detail. First, a DLNA network configuration on which the present invention is based will be explained. FIG. 3 depicts the DLNA network configuration. As shown in FIG. 3, the DLNA network includes a network N₁ of a wireless-LAN (local area network) network portion and a network N₂ of a wire LAN network portion.

The network N₁ is connected with the network N₂ through a gateway of an access point (AP) 500. A DMS device 300a, which is a digital camera, a DMS device 300b, which is a digital video camera, a DMC device 200, which is a cellular phone, and a DMS device 300c, which is a mobile computer, are connected to the network N₁. Each of the devices has an interface necessary for wireless network connection. The DMS devices 200, 300a, 300b, and 300c in FIG. 3 are only examples of a device type. The mobile computer can function not only as a DMS device but also as a digital media renderer (DMR) device or a DMC device, which will be described later.

A DMS device 300d, which is a server device, a DMR device 400a, which is a display monitor, a DMS device 300e, which is a hard disk recorder, and a DMR device 400b, which is a television device, are connected to the network N₂. Each of the devices has an interface necessary for wire network connection. The DMR device referred to here is a display monitor in DLNA.

In such a network configuration, the DMS devices include one or more DMS devices each having the “sufficient search capability” and one or more DMS devices each not having the “sufficient search capability”. In response to a digital-content retrieval request from a collective retrieval function of any one of a mobile computer (corresponding to the DMS device 300c in FIG. 3) functioning also as the DMP (or DMC) device 200, and a DMP device, which is not shown in FIG. 3 but connected to the network N₁ or N₂, each of the DMS devices returns a result of retrieval from digital contents stored in each DMS device.

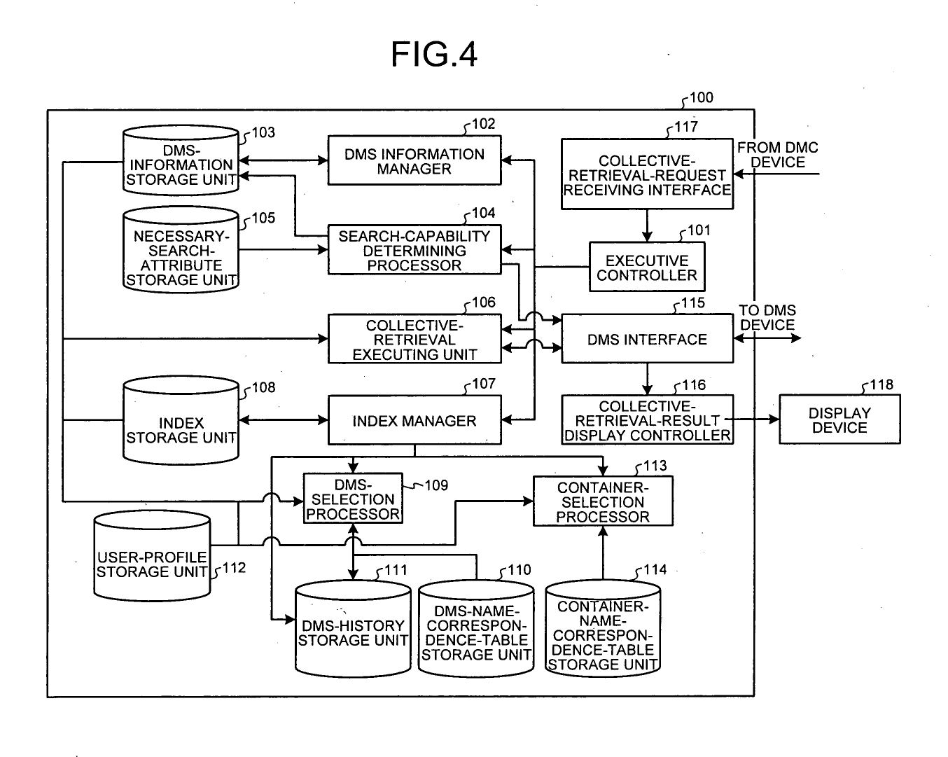

The configuration of a digital-content retrieval apparatus according to the embodiment will be described below. The digital-content retrieval apparatus implements the collective retrieval function of the DMC (or DMP) device 200. As shown in FIG. 4, the digital-content retrieval apparatus 100 has an executive controller 101, a DMS information manager 102, a DMS-information storage unit 103, a search-capability determining processor 104, a necessary-search-attribute storage unit 105, a collective-retrieval executing unit 106, an index manager 107, an index storage unit 108, a DMS-selection processor 109, a DMS-name-correspondence-table storage unit 110, a DMS-history storage unit 111, a user-profile storage unit 112, a container-selection processor 113, a container-name-correspondence-table storage unit 114, a DMS interface 115, a collective retrieval-result display controller 116, and a collective-retrieval-request receiving interface 117. The DMS interface 115 provides a communication interface between the digital-content retrieval apparatus 100 and a DMS device 300. The collective-retrieval-result display controller 116 performs display control so that a result of retrieval from one or more DMS devices 300 having the sufficient search capability and that from one or more DMS devices 300 not having the sufficient search capability are integrally displayed. The collective-retrieval-request receiving interface 117 receives a request for collective retrieval from the DMC 200 and passes the request to the executive controller 101. The digital-content retrieval apparatus 100 is connected to a display device 118, which is a display unit such as a display monitor, by way of the collective-retrieval-result display controller 116.

The executive controller 101 transmits a device detecting request to a plurality of DMS devices 300. Upon receipt of an existing notification from any one of the DMS devices 300, the executive controller 101 instructs the DMS information manager 102 to register DMS information on the DMS device in the DMS-information storage unit 103 or to check whether the DMS information on the DMS device 300 has been registered in the DMS-information storage unit 103. Upon receipt of a leaving notification from any one of the DMS devices 300, the executive controller 101 instructs the DMS information manager 102 to delete DMS information on the DMS device 300 from the DMS-information storage unit 103.

Upon receipt of a content-change notification from any one of the DMS devices 300, the executive controller 101 instructs the DMS information manager 102 to check whether DMS information on the DMS device 300 has been registered in the DMS-information storage unit 103. In response to the request for collective retrieval received through the collective-retrieval-request receiving interface 117, the executive controller 101 instructs the collective-retrieval executing unit 106 to conduct collective retrieval from the plurality of DMS devices 300. When the power for the digital-content retrieval apparatus 100 is shut down, the executive controller 101 instructs the DMS information manager 102 to delete all DMS information stored in the DMS-information storage unit 103.

The executive controller 101 instructs the search-capability determining processor 104 to determine whether each of the DMS devices 300 has the search capability. Upon receipt of any one of an existing notification, a leaving notification, and a content-change notification from any one of the DMS devices 300, the executive controller 101 instructs the index manager 107 to index the DMS device 300.

According to the instruction from the executive controller 101, the DMS information manager 102 registers the DMS information on the DMS device 300, with which the received existing notification is concerned, in the DMS-information storage unit 103. According to the instruction from the executive controller 101, the DMS information manager 102 checks whether the DMS information on the DMS device 300, with which the received existing notification is concerned, has been registered in the DMS-information storage unit 103. According to the instruction from the executive controller 101, the DMS information manager 102 deletes the DMS information on the DMS device 300, with which the received leaving notification is concerned, from the DMS-information storage unit 103.

The DMS-information storage unit 103 is a storage unit, such as a database, that stores attribute information on the DMS device 300. The DMS-information storage unit 103 stores DMS information (an ID and information as to whether the device has the sufficient search capability) pertaining to the DMS device 300, with which the received existing notification is concerned.

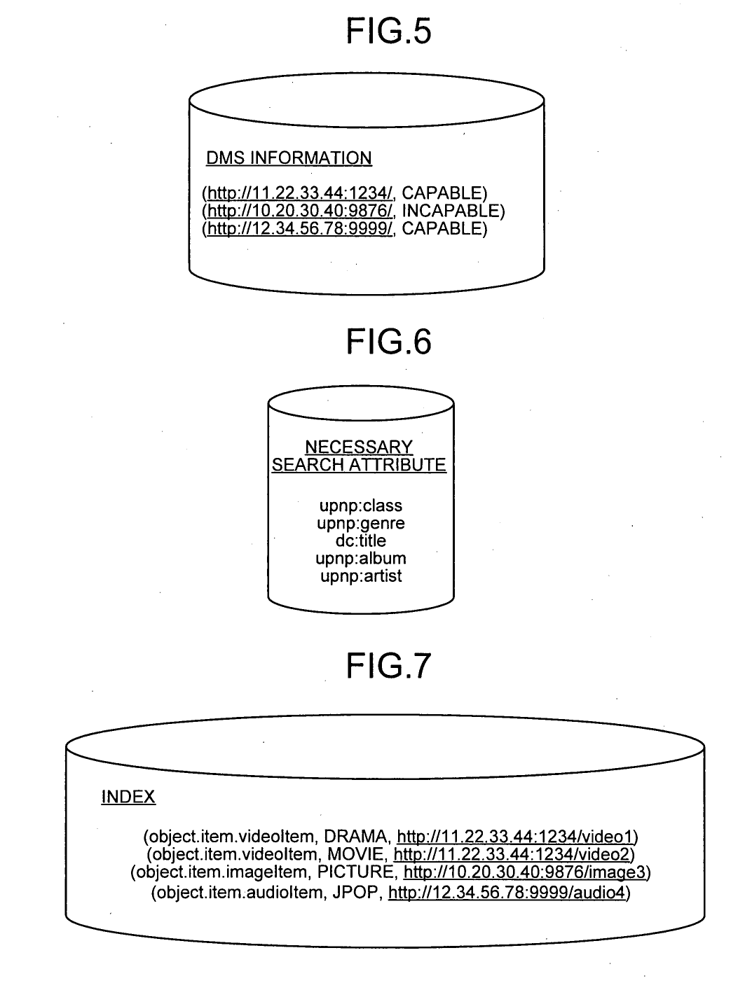

By way of example, as shown in FIG. 5, the DMS-information storage unit 103 stores uniform resource locator (URL) information and information as to whether the DMS device 300 has the search capability for each DMS device 300 in a table. The URL information serves as identification (ID) of a DMS device for specifying the DMS device 300 by a combination of an internet protocol (IP) address and a port number. As shown in FIG. 5, examples of the DMS information include: the DMS device 300 with ID “http://11.22.33.44:1234/” is “capable” of conducting sufficient retrieval; the DMS device 300 with ID “http://10.20.30.40:9876/” is “incapable” of conducting sufficient retrieval; and the DMS device 300 with ID “http://12.34.45.78:9999/” is “capable” of conducting sufficient retrieval.

The DMS information shown in FIG. 5 is stored in a predetermined table through execution of a program that performs a process procedure for registering DMS information.

According to the instruction from the executive controller 101, the search-capability determining processor 104 transmits to the DMS device 300 a command, such as “GetSearchCapabilities”, for inquiring whether the DMS device 300 has a search capability or whether the device has the sufficient search capability, and determines whether the DMS device 300 has the sufficient search capability based on a result of the inquiry returned from the DMS device 300. Thus, whether the DMS device 300 has the search capability; and, further, when the DMS device 300 is determined to have the capability, whether the device 300 has a search attribute necessary for retrieval is determined. A result of the determination made by the search-capability determining processor 104 is stored in the DMS-information storage unit 103. In determination of the search capability of the DMS device 300, the search-capability determining processor 104 determines whether the DMS device 300 has the “sufficient” search capability based on a necessary search attribute fetched by referring to the necessary-search-attribute storage unit 105, which will be described later.

The necessary-search-attribute storage unit 105 is a storage unit, such as a database, that stores necessary attribute information which must be provided in the DMS device 300 having the sufficient search capability. The necessary search attribute varies depending on what characteristic of a digital content is to be extracted using a user profile, which will be described later, stored in the user-profile storage unit 112.

By way of example, as shown in FIG. 6, the necessary-search-attribute storage unit 105 stores search attributes that must be provided in the DMS device 300 having the sufficient search capability in a table. As shown in FIG. 6, examples of necessary search attribute information include “upnp:class” (“class” is information indicating a type of a digital content, such as “moving images” and “voice”), “upnp:genre” (“genre” denotes a type of the digital content, such as “movie”, “documentary”, and “JPOP (Japanese pop music)”), “dc:title” (“title” denotes a title of the digital content), “upnp:album” (“album” denotes a title of an album in which the digital content is contained), and “upnp:artist” (“artist” denotes an artist name of the digital content).

In response to the instruction from the executive controller 101, the collective-retrieval executing unit 106 executes collective retrieval from the plurality of DMS devices 300 in different manners according to whether each of the DMS devices 300 has the sufficient search capability.

In response to the instruction from the executive controller 101, the index manager 107 creates an index and stores the index in the index storage unit 108, deletes an index from the index storage unit 108, and updates an index stored in the index storage unit 108.

The index storage unit 108 is a storage unit, such as a database, that stores a list of content information (necessary search attribute values and content IDs) for use in retrieval of a content from the DMS device 300 not having the sufficient search capability. By way of example, as shown in FIG. 7, the index storage unit 108 stores indexes in a table. FIG. 7 is an example in which the necessary search attributes are “upnp:class” and “upnp:genre”. Each of the necessary search attribute values and the content IDs are contained in content information on a corresponding digital content.

Examples of the index shown in FIG. 7 include: “object.item.videoItem, drama, http://11.22.33.44:1234/video1” (where “object.item.videoItem” and “drama” are “upnp:class” and “upnp:genre”, respectively, and “http://11.22.33.44:1234/video1” is an index), “object.item.videoItem, movie, http://11.22.33.44:1234/video2” (where “object.item.videoItem” and “movie” are “upnp:class” and “upnp:genre”, respectively, and “http://11.22.33.44:1234/video2” is an index), and “object.item.imageItem, picture, http://10.20.30.40:9876/image3” (where “object.item.imageItem” and “picture” are “upnp:class” and “upnp:genre”, respectively, and “http://10.20.30.40:9876/image3” is an index). Thus, because the content information on the digital content of the DMS device, for which the indexes are created, is stored on a DMS-by-DMS basis, retrieval-by-index of a digital content based on a necessary attribute from the DMS device is attained.

The indexes shown in FIG. 7 are stored in a predetermined table through execution of a program that performs a process procedure for registering indexes.

The DMS-selection processor 109 refers to information (information contained in a DMS history, which will be described later, stored in the DMS-history storage unit 111) about digital contents frequently used by a user, and assigns priorities to the DMS devices 300 to be indexed.

The DMS-name-correspondence-table storage unit 110 is a storage unit, such as a database, that stores an information list. The list associates a name of a DMS device and information about digital contents being held by the DMS device. By way of example, as shown in FIG. 10, the DMS-name-correspondence-table storage unit 110 stores DMS device names with necessary search attributes associated therewith in a table. FIG. 10 is an example in which the necessary search attributes are “upnp:class” and “upnp:genre”. Each of the necessary search attribute values is contained in content information on a corresponding digital content.

Examples of the DMS-name correspondence table shown in FIG. 10 include: “HDD-R1, object.item.videoItem, (drama, movie)” (where “HDD-R1” is a DMS device name, and “object.item.videoItem” and “(drama, movie)” are “upnp:class” and “upnp:genre”, respectively), “digital camera 2, object.item.imageItem, picture” (where “digital camera 2” is a DMS device name, and “object.item.imageItem” and “picture” are “upnp:class” and “upnp:genre”, respectively), and “cellular phone 3, object.item.audioItem, JPOP” (where “cellular phone 3” is a DMS device name, and “object.item.audioItem” and “JPOP” are “upnp:class” and “upnp:genre”, respectively).

The DMS-history storage unit 111 is a storage unit, such as a database, that stores a DMS history. The DMS history is history information (a list of DMS-device IDs and contents having been held by each DMS device 300) indicating what digital contents have been held by each DMS device 300 that has ever been indexed. By way of example, as shown in FIG. 9, the DMS-history storage unit 111 stores URLs of DMS devices with necessary search attributes associated therewith in a table. FIG. 9 is an example in which the necessary search attributes are “upnp:class” and “upnp:genre”. Each of the necessary search attribute values is contained in content information on a corresponding digital content.

Examples of the DMS history shown in FIG. 9 include: “http://11.22.33.44:1234, object.item.videoItem, (drama, movie)” (where “http://11.22.33.44:1234” is a URL of the DMS device, and “object.item.videoItem” and “(drama, movie)” are “upnp:class” and “upnp:genre”, respectively), “http://10.20.30.40:9876, object.item.imageItem, picture” (where “http://10.20.30.40:9876” is a URL of the DMS device, and “object.item.imageItem” and “picture” are “upnp:class” and “upnp:genre”, respectively), and “http://12.34.56.78:9999, object.item.audioItem, JPOP” (where “http://12.34.56.78:9999” is a URL of the DMS device, and “object.item.audioItem” and “JPOP” are “upnp:class” and “upnp:genre”, respectively).

The DMS history shown in FIG. 9 is stored in a predetermined table through execution of a program that performs a process procedure for registering a DMS history.

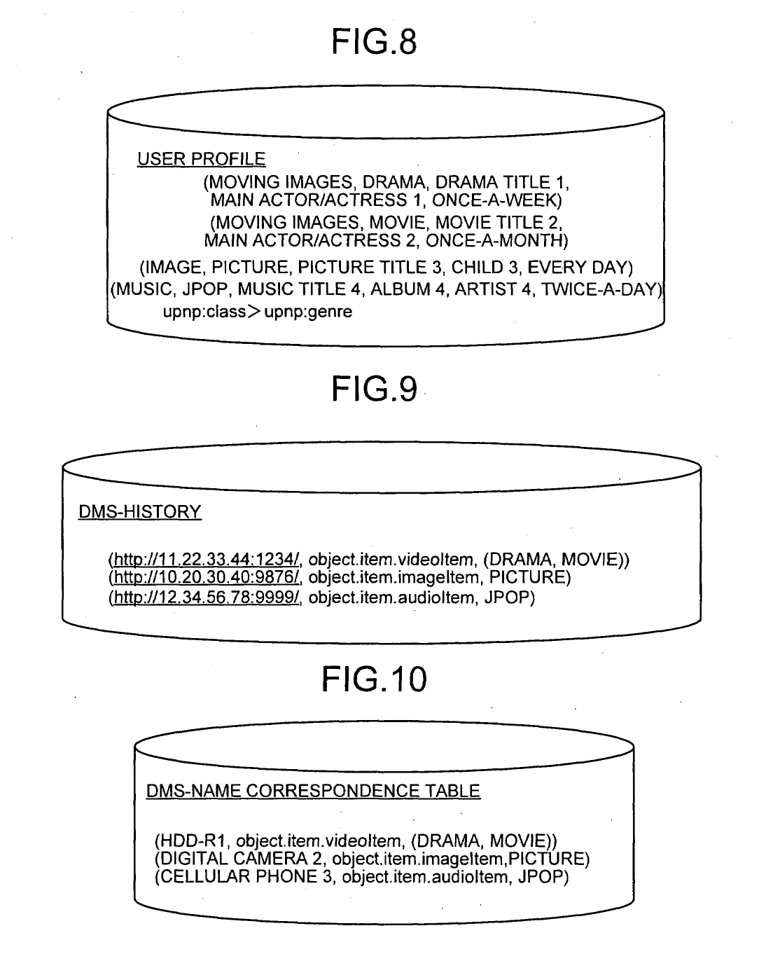

The user-profile storage unit 112 is a storage unit, such as a database, that stores a user profile. The profile includes a usage history about digital contents used by a user and prioritized search attributes. The content usage history referred to here is information indicating which content has been used at what usage frequency. The prioritized search attributes are search attributes that should be prioritized in making determination as to whether the content is frequently used. By way of example, as shown in FIG. 8, the user-profile storage unit 112 stores necessary search attributes with usage frequencies associated therewith in a table. FIG. 8 is an example in which the necessary search attributes are “upnp:class”, “upnp:genre”, “dc:title”, “upnp:album”, and “upnp:artist”. Each of the necessary search attribute values is contained in content information on a corresponding digital content.

Examples of the user profile shown in FIG. 8 include: (moving images, drama, drama title 1, main actor/actress 1, once-a-week) (where “moving images” is “upnp:class”, “drama” is “upnp:genre”, “drama title 1” is “dc:title”, “main actor/actress 1” is “upnp:artist”, and “once-a-week” is the usage frequency), (moving images, movie, movie title 2, main actor/actress 2, once-a-month) (where “moving images” is “upnp:class”, “movie” is “upnp:genre”, “movie title 2” is “dc:title”, “main actor/actress 2” is “upnp:artist”, and “once-a-month” is the usage frequency), (image, picture, picture title 3, child 3, every day) (where “image” is “upnp:class”, “picture” is “upnp:genre”, “picture title 3” is “dc:title”, “child 3” is “upnp:artist”, and “every day” is the usage frequency), (music, JPOP, music title 4, album 4, artist 4, twice-a-day) (where “music” is “upnp:class”, “JPOP” is “upnp:genre”, “music title 4” is “dc:title”, “album 4” is “upnp:album”, “artist 4” is “upnp:artist”, and “twice-a-day” is the usage frequency).

The user profile contains information about a priority of a search attribute used in determining a usage frequency of a content. The example user profile shown in FIG. 8 includes information of “upnp:class>upnp:genre”, which indicates that “upnp:class” is in higher priority than “upnp:genre”.

The container-selection processor 113 refers to a container-name correspondence table, which will be described later, stored in the container-name-correspondence-table storage unit 114, and determines priorities of containers to be indexed based on information about contents frequently used by the user. The container referred to here is a logical storage area in which digital contents held in each DMS device 300 are to be stored. The containers are in a hierarchical structure.

The container-name-correspondence-table storage unit 114 stores a correspondence table of values designated as search attributes and actual container names. Variations in notation (e.g., expression by synonyms, mix-up of uppercase/lowercase characters, and mix-up of double-byte/single-byte characters) cause inconvenience that, even when some container names practically represent a single container, the names fail to be recognized as being identical. To avoid such inconvenience, the container-name correspondence table functions as a thesaurus. For example, when a container's “upnp:class” is “object.item.videoItem”, the name of the container can take “moving images”, “images”, “video (in double-byte characters)”, “video”, “Video”, “VIDEO”, “VIDEO (in double-byte characters)”, and the like. Using the container-name correspondence table allows all of these container names to be recognized to indicate the single container in practice.

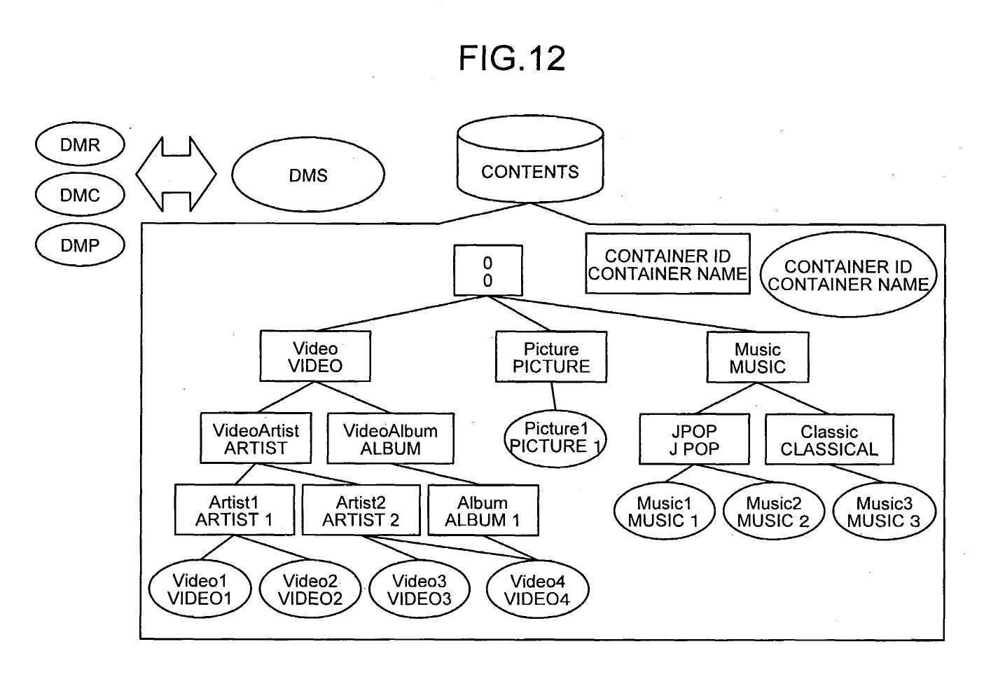

The structure of containers of the DMS device 300 is described below. FIG. 12 depicts the container structure of the DMS device 300. As shown in FIG. 12, in the DMS device 300, containers each specified by a container ID and a container name are hierarchically arranged in a tree structure. For example, containers of “video”, “picture”, and “music” belong to a lower layer of the root container “0”. A digital content “video 1” belongs to a lower layer of the container “artist 1”. Thus, in the tree structure, either only one or more containers or only one or more digital contents belong to a lower layer of a container. The digital contents belong to lower-end layers of the tree structure. As shown in FIG. 12, a digital content “video 4” belongs to two containers of “artist 2” and “album 1”. Thus, a digital content is allowed to belong to a plurality of containers.

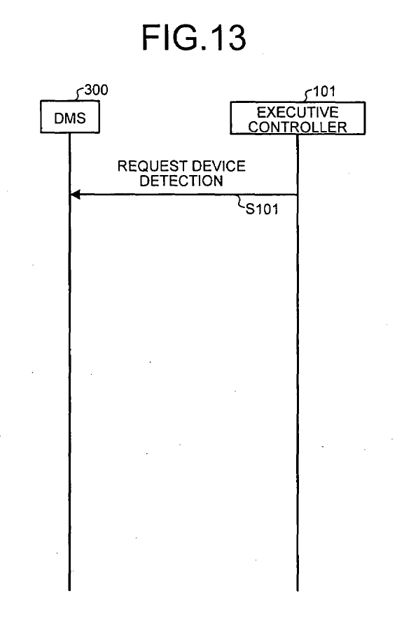

Processes performed by the digital-content retrieval apparatus 100 shown in FIG. 4 at startup thereof will be described below. FIG. 13 is a time chart of the processes. As shown in FIG. 13, upon startup of the digital-content retrieval apparatus 100, the executive controller 101 of the digital-content retrieval apparatus 100 transmits a device detecting request to the plurality of DMS devices 300 (step S101). This is because, since the DMS device 300 is easily connected to or separated from the network N₁ or N₂, constant monitoring for new connection of the DMS device 300 is required. In particular, the DMS device 300 is easily connected or separated to and from a wireless network. Therefore, the processes shown in FIG. 13 are more highly required by such a wireless network, such as the network N₁.

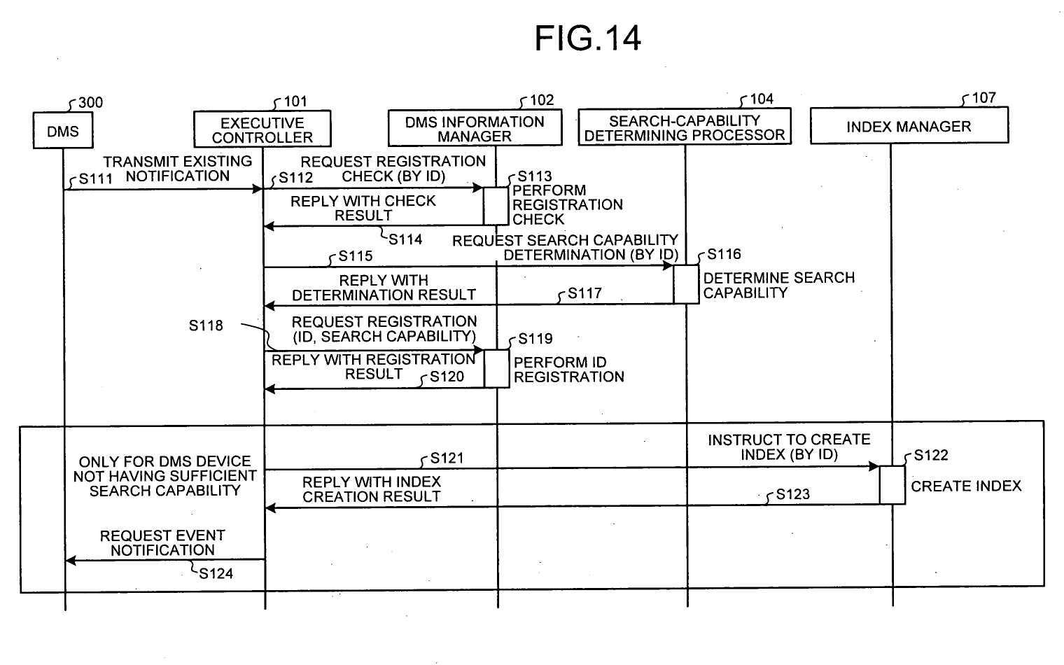

Processes performed by the digital-content retrieval apparatus 100 when the DMS device 300, with DMS information thereon unregistered, is newly detected in response to transmission of the device detecting request at step S101 of FIG. 13 will be described below. FIG. 14 is a time chart of the processes performed when the DMS device 300 (with the DMS information thereon unregistered) is newly detected. As shown in FIG. 14, first, the DMS device 300 transmits an existing notification to the executive controller 101 of the digital-content retrieval apparatus 100 (step S111). Upon receipt of the notification, the executive controller 101 transmits a request, with designation of the DMS device 300 by its ID, to the DMS information manager 102 to check whether DMS information on the DMS device 300 has been registered (step S112). In response to the registration check request issued at step S112, the DMS information manager 102 refers to the DMS-information storage unit 103 and checks whether the DMS information has been registered (step S113), and transmits a result of the check to the executive controller 101 (step S114). Meanwhile, “unregistered” is transmitted to the executive controller 101 at step S114 as the check result.

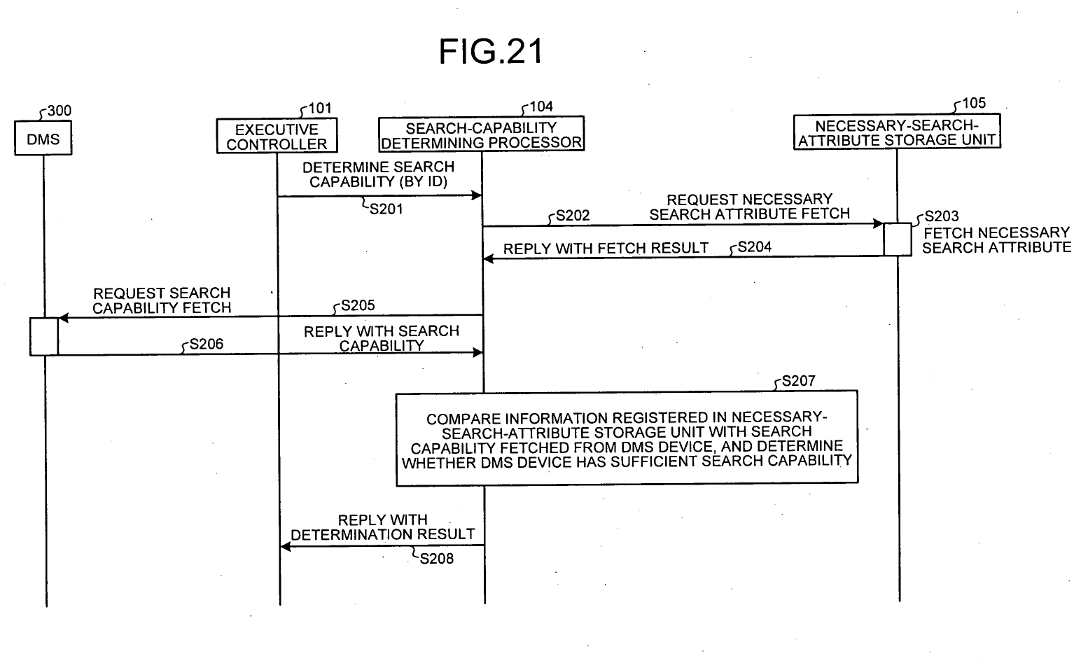

The executive controller 101 transmits a request, with designation of the DMS device 300 by its ID, to the search-capability determining processor 104 to determine the search capability of the DMS device 300 (step S115). Upon receipt of the request, the search-capability determining processor 104 determines the search capability of the DMS device 300 (step S116). Processes of determining the search capability will be described later with reference to FIG. 21. The search-capability determining processor 104 transmits a result of the search capability determination to the executive controller 101 (step S117).

The executive controller 101 transmits an instruction to register the ID of the DMS device 300 and whether the DMS device 300 specified by the ID has the search capability to the DMS information manager 102 (step S118). Upon receipt of the instruction, the DMS information manager 102 registers the DMS information in the DMS-information storage unit 103 (step S119). When registration of the DMS information is completed, the DMS information manager 102 transmits a result of the registration to the executive controller 101 (step S120).

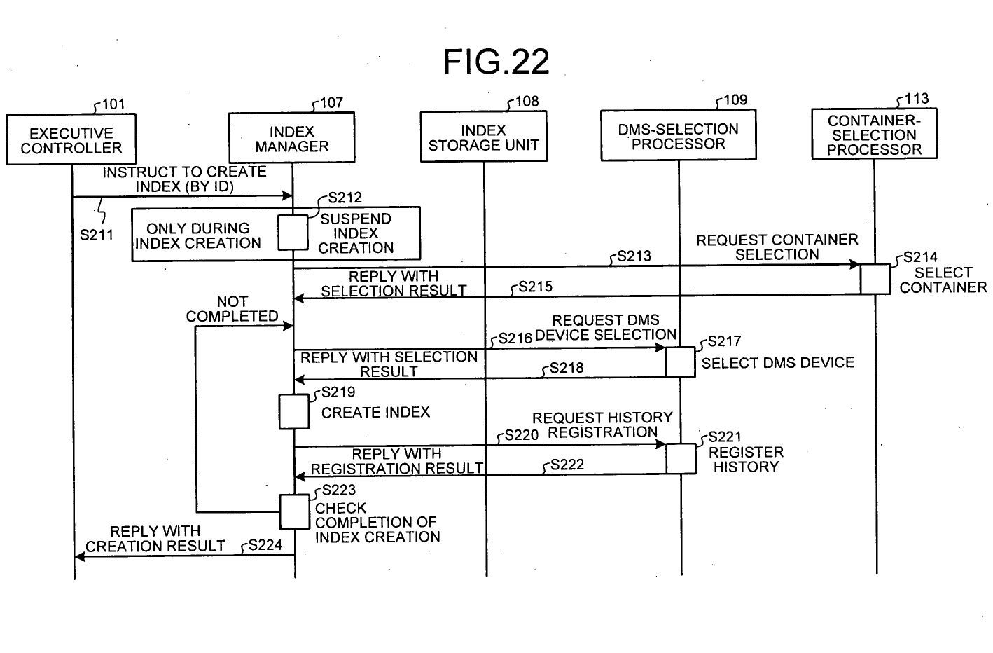

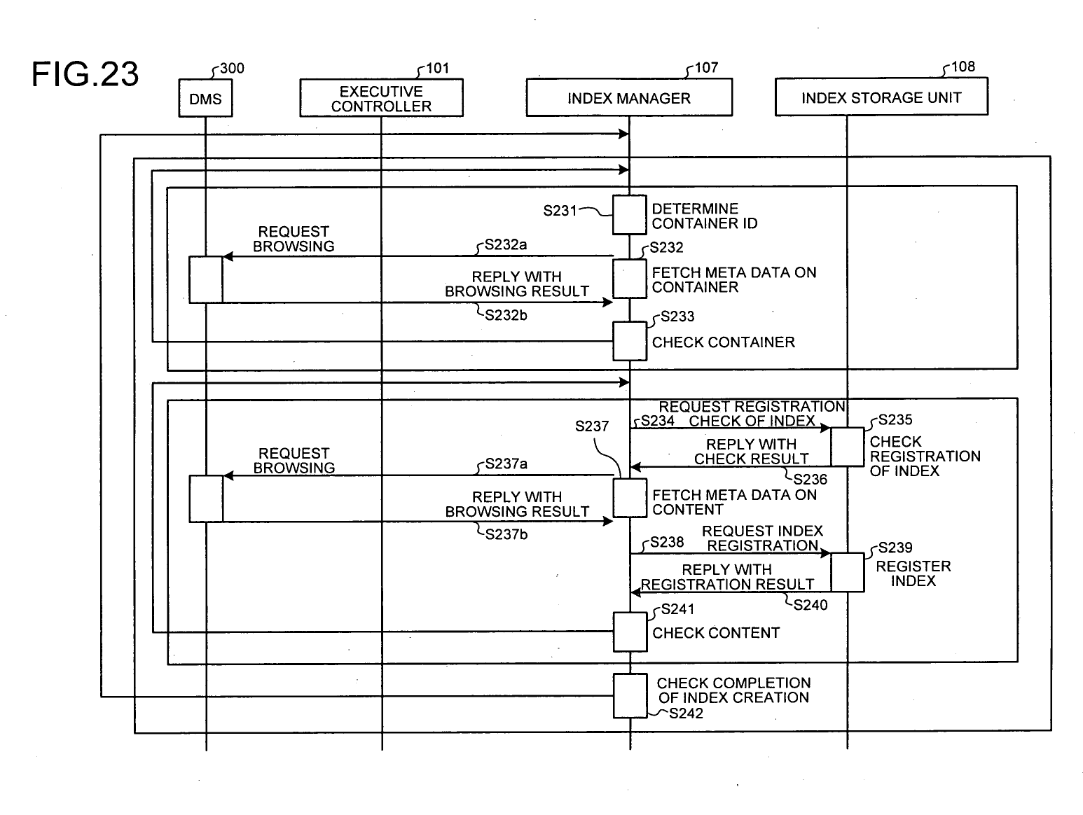

Only the DMS devices 300 determined not to have the sufficient search capability are subjected to the following process. The executive controller 101 instructs the index manager 107 to create indexes of the DMS device 300 designated by its ID (step S121). Upon receipt of the instruction, the index manager 107 indexes the DMS device 300 (step S122). Processes of creating the indexes will be described later with reference to FIGS. 22 and 23. When creation of the index is completed, the index manager 107 transmits a result of the index creation to the executive controller 101 (step S123). The executive controller 101 transmits an event notification request to the DMS device 300 (not having the sufficient search capability) (step S124). The event referred to here is a status change, such as addition, update, and deletion of data in a digital content of the DMS device 300.

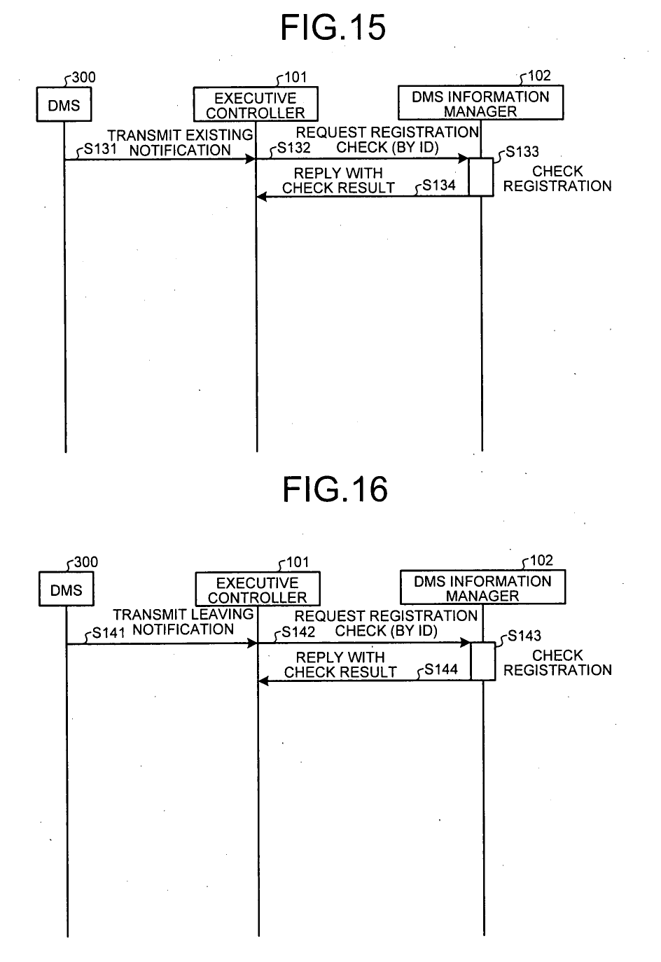

Processes performed by the digital-content retrieval apparatus 100 when the DMS device 300, with the DMS information thereon having been registered, is newly detected in response to the device detecting request issued at step S101 shown in FIG. 13 will be described below. FIG. 15 is a time chart of the processes performed when the DMS device 300 (with the DMS information thereon having been registered) is newly detected. As shown in FIG. 15, first, the DMS device 300 transmits an existing notification to the executive controller 101 of the digital-content retrieval apparatus 100 (step S131). Upon receipt of the notification, the executive controller 101 transmits a request, with designation of the DMS device 300 by its ID, to the DMS information manager 102 to check whether DMS information on the DMS device 300 has been registered (step S132). In response to the request issued at step S132, the DMS information manager 102 refers to the DMS-information storage unit 103 and checks whether the DMS information has been registered (step S133), and transmits a result of the check to the executive controller 101 (step S134). Because “registered” is transmitted to the executive controller 101 at step S114 as the check result, registration of the DMS information on the DMS device 300 is not required.

Processes performed by the digital-content retrieval apparatus 100 when the DMS device 300, with the DMS information thereon unregistered, notifies of leaving the network will be described below. FIG. 16 is a time chart of the processes performed when the DMS device 300 (with the DMS information thereon unregistered) is leaving. As shown in FIG. 16, first, the DMS device 300 transmits a leaving notification to the executive controller 101 of the digital-content retrieval apparatus 100 (step S141). Upon receipt of the notification, the executive controller 101 transmits a request, with designation of the DMS device 300 by its ID, to the DMS information manager 102 to check whether the DMS information on the DMS device 300 has been registered (step S142). In response to the request issued at step S142, the DMS information manager 102 refers to the DMS-information storage unit 103 and checks whether the DMS information has been registered (step S143), and transmits a result of the check to the executive controller 101 (step S144). Because “unregistered” is transmitted to the executive controller 101 at step S144 as the check result, deletion of the DMS information on the DMS device 300 is not required.

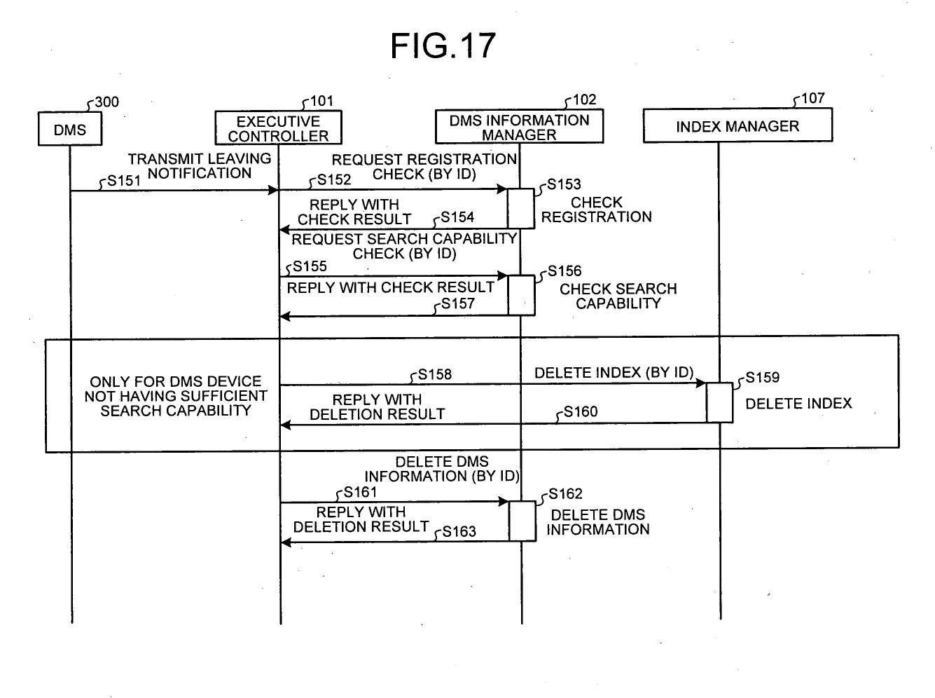

Processes performed by the digital-content retrieval apparatus 100 when the DMS device 300, with the DMS information thereon having been registered, notifies of leaving the network will be described below. FIG. 17 is a time chart of the processes performed when the DMS device 300 (with the DMS information thereon having been registered) is leaving. As shown in FIG. 17, first, the DMS device 300 transmits a leaving notification to the executive controller 101 of the digital-content retrieval apparatus 100 (step S151). Upon receipt of the notification, the executive controller 101 transmits a request, with designation of the DMS device 300 by its ID, to the DMS information manager 102 to check whether DMS information on the DMS device 300 has been registered (step S152). In response to the request issued at step S152, the DMS information manager 102 refers to the DMS-information storage unit 103 and checks whether the DMS information has been registered (step S153), and transmits a result of the check to the executive controller 101 (step S154). “Registered” is transmitted to the executive controller 101 at step S154 as the check result.

The executive controller 101 transmits a request, with designation of the DMS device 300 by its ID, to the DMS information manager 102 to check the search capability of the DMS device 300 (step S155). Upon receipt of the request, the DMS information manager 102 refers to the DMS-information storage unit 103 and checks the search capability of the DMS device 300 (step S156). The DMS information manager 102 transmits a result of the check to the executive controller 101 (step S157). When processing pertaining to step S157 ends, processing proceeds to step S158 or S161.

Only the DMS devices 300 not having the sufficient search capability are subjected to processes pertaining to steps S158 to S160 below, while DMS devices 300 having the sufficient search capability are not subjected to the same. The executive controller 101 instructs the index manager 107 to delete an index of the DMS device 300 with designation of the DMS device 300 by its ID (step S158). Upon receipt of the instruction, the index manager 107 deletes the index from the index storage unit 108 (step S159). When deletion of the index is completed, the index manager 107 transmits a result of the index deletion to the executive controller 101 (step S160). The executive controller 101 instructs the DMS information manager 102 to delete the DMS information on the DMS device 300, with designation of the DMS device 300 by its ID (step S161). Upon receipt of the instruction, the DMS information manager 102 deletes the DMS information from the DMS-information storage unit 103 (step S162). When deletion of the DMS information is completed, the DMS information manager 102 transmits a result of the DMS information deletion to the executive controller 101 (step S163).

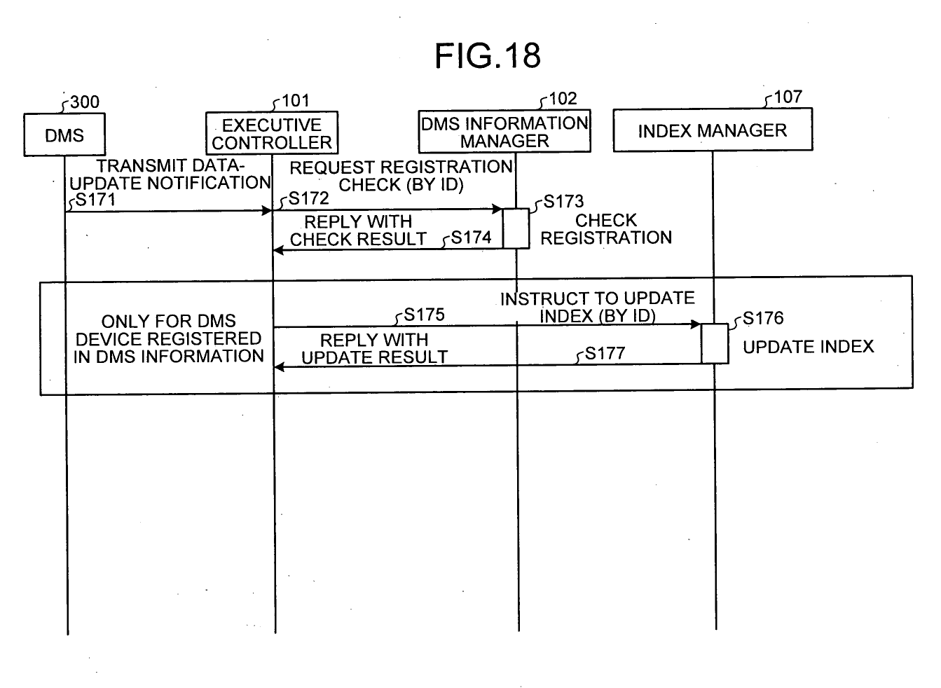

Processes performed by the digital-content retrieval apparatus 100 upon receipt of an event notification from the DMS device 300 will be described below. FIG. 18 is a time chart of the processes performed to update the DMS device 300. As shown in FIG. 18, first, the DMS device 300 transmits a data-update notification related to a digital content to the executive controller 101 of the digital-content retrieval apparatus 100 (step S171). Upon receipt of the notification, the executive controller 101 transmits a request, with designation of the DMS device 300 by its ID, to the DMS information manager 102 to check whether DMS information on the DMS device 300 has been registered (step S172). In response to the request issued at step S172, the DMS information manager 102 refers to the DMS-information storage unit 103 and checks whether the DMS information has been registered (step S173), and transmits a result of the check to the executive controller 101 (step S174). “Registered” is transmitted to the executive controller 101 at step S174 as the check result.

Only the DMS devices 300 with the DMS information thereon registered are subjected to processes pertaining to steps S175 to S177 below, while the DMS devices 300 with the DMS information thereon unregistered are not subjected to the same. The executive controller 101 instructs the index manager 107 to update the index of the DMS device 300 with designation of the DMS device 300 by its ID (step S175). Upon receipt of the instruction, the index manager 107 updates the index in the index storage unit 108 (step S176). When updating the index is completed, the index manager 107 transmits a result of the index update to the executive controller (step S177).

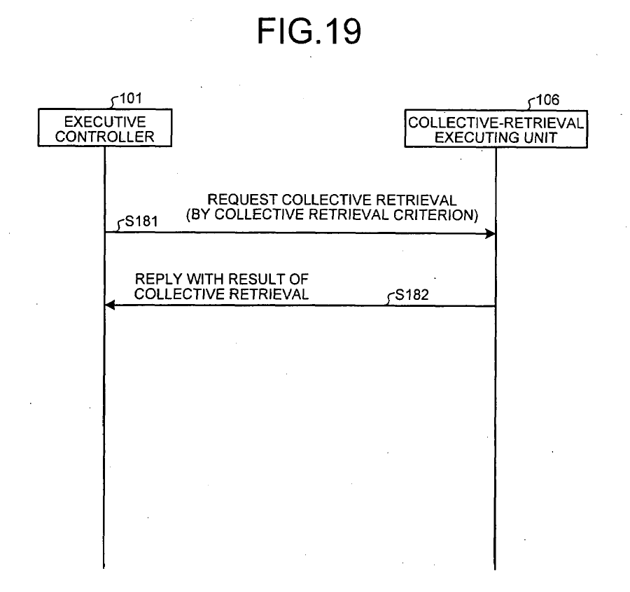

Collective retrieval performed by the digital-content retrieval apparatus 100 shown in FIG. 4 will be described below. FIG. 19 is a time chart of processes of the collective retrieval performed by the digital-content retrieval apparatus 100. As shown in FIG. 19, first, the executive controller 101 of the digital-content retrieval apparatus 100 transmits a request to the collective-retrieval executing unit 106 to conduct collective retrieval with designation of a collective retrieval criterion (step S181). In response to the collective retrieval execution request, the collective-retrieval executing unit 106 transmits a result of the collective retrieval to the collective retrieval-result display controller 116 (step S182).

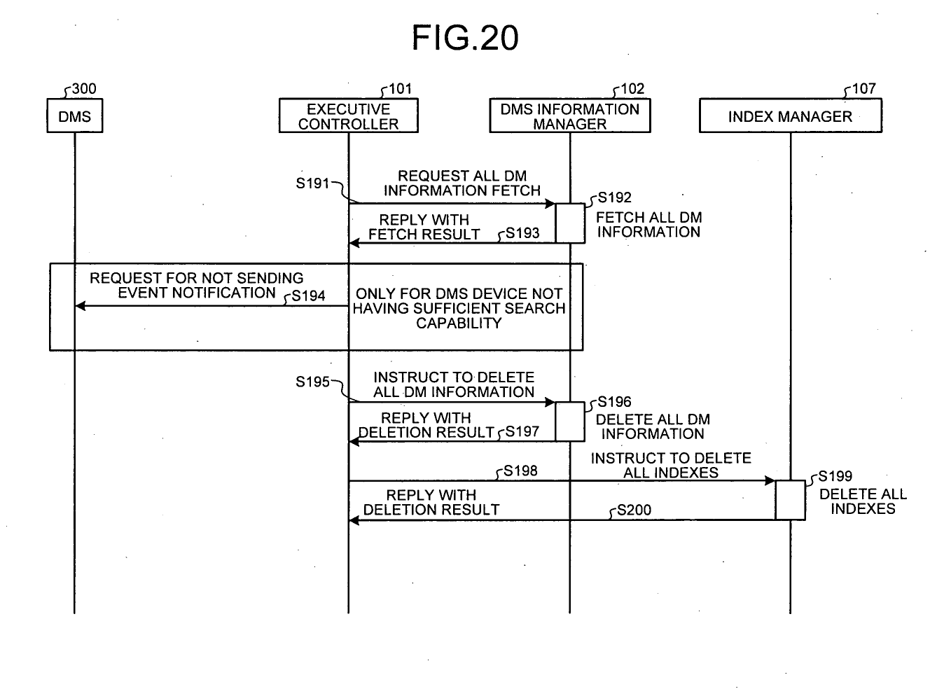

Processes performed by the digital-content retrieval apparatus 100 shown in FIG. 4 when the power therefor is shut down will be described below. FIG. 20 is a time chart of the processes. As shown in FIG. 20, first, the executive controller 101 of the digital-content retrieval apparatus 100 transmits a request to the DMS information manager 102 to fetch DMS information on all the DMS devices 300 (step S191). In response to the request, the DMS information manager 102 refers to the DMS-information storage unit 103 and fetches DMS information on all the DMS devices 300 (step S192), and transmits a result of the fetch to the executive controller 101 (step S193). When processing pertaining to step S193 ends, processing proceeds to step S194 or S195.

Only the DMS devices 300 not having the sufficient search capability are subjected to processes pertaining to step S94 below, while the DMS devices 300 having the sufficient search capability are not subjected to the same. A request for not sending an event notification is transmitted to the DMS devices 300 not having the sufficient search capability (step S194). This prevents a notification of an event to be supplied from the DMS devices 300 not having the sufficient search capability.

The executive controller 101 instructs the DMS information manager 102 to delete the DMS information on all the DMS devices 300 (step S195). Upon receipt of the instruction, the DMS information manager 102 deletes the DMS information on all the DMS devices 300 from the DMS-information storage unit 103 (step S196). When deletion of the DMS information on all the DMS devices 300 is completed, the DMS information manager 102 transmits a result of the deletion to the executive controller 101 (step S197). The executive controller 101 instructs the index manager 107 to delete the indexes of all the DMS devices 300 (step S198). Upon receipt of the instruction, the index manager 107 deletes all the indexes from the index storage unit 108 (step S199). When deletion of all the indexes is completed, the index manager 107 transmits a result of the index deletion to the executive controller 101 (step S200).

Processes pertaining to steps S115 to S117 of FIG. 14 for determining the search capability of the DMS device 300 will be described in detail below. FIG. 21 is a time chart of the processes. As shown in FIG. 21, first, the executive controller 101 of the digital-content retrieval apparatus 100 transmits a request, with designation of the DMS device 300 by its ID, to the search-capability determining processor 104 to determine the search capability of the DMS device 300 (step S201). Upon receipt of the request, the search-capability determining processor 104 requests the necessary-search-attribute storage unit 105 to fetch a “necessary search attribute”, which is necessary for determining the DMS device 300 to have the sufficient search capability (step S202). Upon receipt of the request, the necessary-search-attribute storage unit 105 fetches the necessary search attribute (step S203), and transmits a result of the fetch to the search-capability determining processor 104 (step S204).

The search-capability determining processor 104 requests each of the DMS devices 300 to fetch the search capability of the DMS device 300 based on the retrieved necessary search attribute using a command of “getsearchcapability”, and the like (step S205). In response to the request, the DMS device 300 transmits information as to whether the DMS device 300 has the search capability including the necessary search attribute to the search-capability determining processor 104 (step S206). Upon receipt of the information, the search-capability determining processor 104 compares information stored in the necessary-search-attribute storage unit 105 with the search capability fetched from the DMS device 300 including the necessary search attribute, thereby determining whether the DMS device 300 has the sufficient search capability (step S207). The search-capability determining processor 104 transmits a result of the determination as to whether the DMS device 300 has the sufficient search capability to the executive controller 101 (step S208).

Processes pertaining to steps S121 to S123 of FIG. 14 performed for creating an index will be described in detail below. FIG. 22 is a time chart of the processes. As shown in FIG. 22, first, the executive controller 101 of the digital-content retrieval apparatus 100 instructs the index manager 107 to create an index of the DMS device 300 with designation of the DMS device 300 by its ID (step S211). When the index manager 107 is during the course of index creation, the index creation is suspended (step S212). When the index manager 107 is not during the course of index creation, processing pertaining to step S212 is skipped.

The index manager 107 transmits an instruction to the container-selection processor 113 to select a container (step S213). Upon receipt the instruction, the container-selection processor 113 selects a container, to which a digital content frequently used by the user belongs, as a container to which higher priority is assigned in index creation (step S214), and transmits a result of the selection made at step S214 to the index manager 107 (step S215).

The index manager 107 transmits an instruction to the DMS-selection processor 109 to select one of the DMS devices 300 (step S216). Upon receipt the instruction, the DMS-selection processor 109 selects the DMS device 300 frequently used by the user as the DMS device 300 to which higher priority is assigned in index creation (step S217). The DMS-selection processor 109 transmits a result of the selection made at step S217 to the index manager 107 (step S218).

The index manager 107 creates an index (step S219). The index creation will be described later in detail with reference to FIG. 23. The index manager 107 transmits an instruction to the DMS-selection processor 109 to register a DMS history of the DMS device 300 (step S220). Upon receipt of the instruction, the DMS-selection processor 109 registers the DMS history in the DMS-history storage unit 111 (step S221). The DMS-selection processor 109 transmits a result of the process performed at step S221 to the index manager 107 (step S222).

The index manager 107 checks whether the index creation is completed (step S223). When the index creation is completed, processing proceeds to step S224, while when creation of the index is not completed, processing proceeds to step S216. At step S224, the index manager 107 transmits a result of the index creation to the executive controller 101.

Processes pertaining to step S219 of FIG. 22 for creating the index will be described in detail below. FIG. 23 is a time chart of the processes performed in the (second) index creation. As shown in FIG. 23, first, the index manager 107 of the digital-content retrieval apparatus 100 determines a container ID of the container that is held in the DMS device to be indexed and that contains a digital content to be indexed (step S231). The container ID determined at this step is an ID of the container that is frequently used by a user and therefore assigned higher priority.

The index manager 107 fetches meta data on the container selected at step S231 (step S232). The meta data specifies the position of the container in the tree structure based on a hierarchical structure indicating a parent/child relationship about the container. Specifically, the index manager 107 transmits a browsing request to the DMS device 300 using a command (Browse) that requests browsing (step S232a). Upon receipt of the request, the DMS device 300 transmits a result of the browsing to the index manager 107 (step S232b). Thus, the container, to which the digital content frequently used by the user belongs, is identified. The index manager 107 refers to the container based on the container meta data fetched at step S232, and checks whether the container exists (step S233). When the container is confirmed to exist at step S233 and browsing another container is not required, processing proceeds to step S234. On the other hand, when browsing another container is required, processing proceeds to step S231. Through the processes pertaining to steps S231 to S233, the container is browsed.

At step S234, the index manager 107 refers to the index storage unit 108 and transmits a request to check whether an index of the container confirmed to exist at step S233 has already been created and registered. Upon receipt of the request, the index storage unit 108 checks whether the index has been registered (step S235), and transmits a result of the check to the index manager 107 (step S236). When the container is confirmed to have already been indexed by the check performed at step 235, the processes pertaining to step S237 (steps S237a and S237b) and the processes pertaining to steps S238 to S240 are skipped.

The index manager 107 fetches meta data on the digital content that is held the container to be indexed and that belongs to the DMS device 300 to be indexed (step S237). The meta data specifies the position of the container in the tree structure based on a hierarchical structure indicating a parent/child relationship about the container, and specifies the digital content data by an appended data name of the digital content (step S237). Specifically, the index manager 107 transmits a browsing request to the DMS device 300 using the command (Browse) that requests browsing (step S237a). Upon receipt of the request, the DMS device 300 transmits a result of the browsing to the index manager 107 (step S237b). Hence, the data name of the digital content that belongs to the container frequently used by the user is identified.

The index manager 107 refers to the digital content based on the container meta data fetched at step S237, and requests the index storage unit 108 to register the index of the digital content (step S238). Upon receipt of the request, the index storage unit 108 registers the index (step S239), and transmits a result of the registration to the index manager 107 (step S240).

The index manager 107 checks whether another digital content to be indexed exists (step S241). When no more digital content to be indexed exists, processing proceeds to step S242. On the other hand, when another digital content to be indexed exists, processing proceeds to step S234. Through the processes pertaining to steps S234 to S251, the container is browsed.

The index manager 107 determines whether the index creation is completed (step S242). When the index creation is completed, the (second) index creation ends, while, when the index creation is not completed, processing proceeds to step S231.

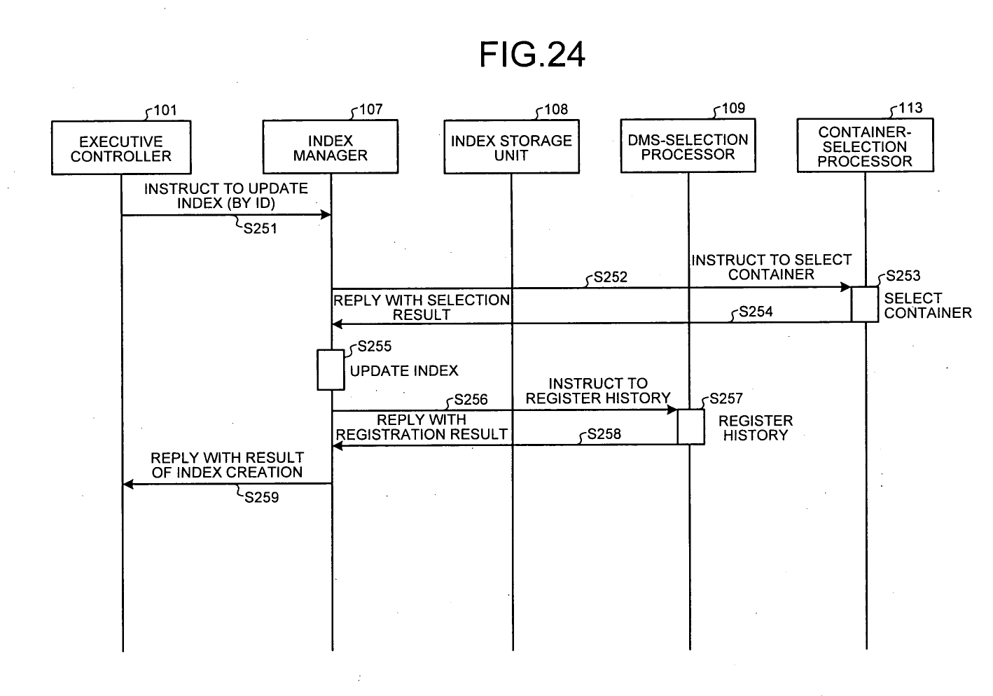

Processes of updating an index performed upon receipt of an event notification that notifies of update of a digital content from the DMS device 300 will be described in detail below. FIG. 24 is a time chart of the processes. As shown in FIG. 24, first, the executive controller 101 of the digital-content retrieval apparatus 100 instructs the index manager 107 to update an index of the DMS device 300 with designation of the DMS device 300 by its ID (step S251).

The index manager 107 transmits an instruction to the container-selection processor 113 to select a container (step S252). Upon receipt the instruction, the container-selection processor 113 selects the container, to which the updated digital content belongs (step S253). The container-selection processor 113 transmits a result of the selection made at step S253 to the index manager 107 (step S254).

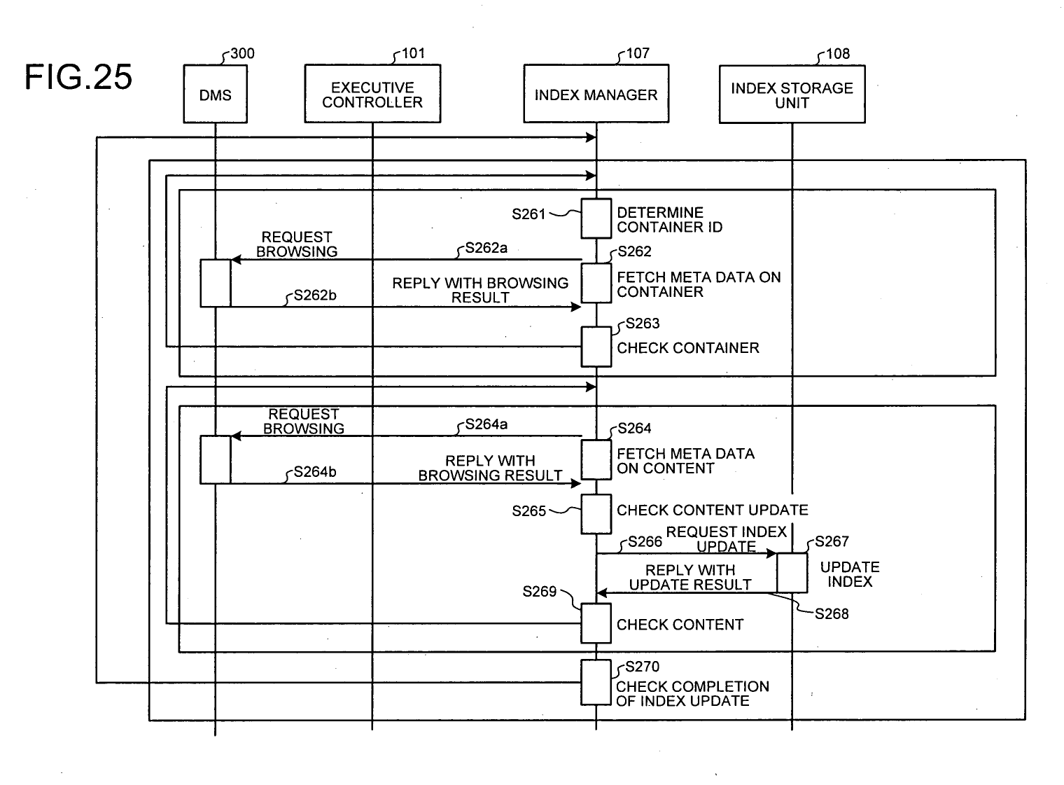

Subsequently, the index manager 107 updates the index (step S255). This process will be described later in detail with reference to FIG. 25. The index manager 107 transmits an instruction to the DMS-selection processor 109 to register a DMS history (step S256). Upon receipt of the instruction, the DMS-selection processor 109 registers the DMS history in the DMS-history storage unit 111 (step S257). The DMS-selection processor 109 transmits a result of the registration performed at step S257 to the index manager 107 (step S258). The index manager 107 transmits a result of the index creation to the executive controller 101 (step S259).

Processes pertaining to step S255 of FIG. 24 for updating the index will be described in detail below. FIG. 25 is a time chart of the processes performed in the (second) index update. As shown in FIG. 25, first, the index manager 107 of the digital-content retrieval apparatus 100 determines a container ID of the container that is held in the DMS device 300, of which index is to be updated, and that contains the digital content, of which index is to be updated (step S261).

The index manager 107 fetches meta data on the container selected at step S261 (step S262). The meta data specifies the position of the container in the tree structure based on a hierarchical structure indicating a parent/child relationship about the container. Specifically, the index manager 107 transmits a browsing request to the DMS device 300 using the command (Browse) that requests browsing (step S262a). Upon receipt of the request, the DMS device 300 transmits a result of the browsing to the index manager 107 (step S262b). Hence, the container, of which index is to be updated, is identified. The index manager 107 refers to the container based on the container meta data fetched at step S262, and checks whether the container exists (step S263). When the container, of which index is to be updated, is found at step S263 and browsing another container is not required, processing proceeds to step S264. On the other hand, when browsing another container is required, processing proceeds to step S261. Through the processes pertaining to steps S261 to S263, the container is browsed.

The index manager 107 fetches meta data on the digital content that belongs to the container to be indexed and that is held in the DMS device 300 to be indexed (step S264). The meta data specifies the position of the container in the tree structure based on a hierarchical structure indicating a parent/child relationship about the container, and specifies the digital content data by an appended data name of the digital content. Specifically, the index manager 107 transmits a browsing request to the DMS device 300 using the command (Browse) that requests browsing (step S264a). Upon receipt of the request, the DMS device 300 transmits a result of the browsing to the index manager 107 (step S264b). Hence, the data name of the digital content that belongs to the container, of which index is to be updated, is identified.

The index manager 107 refers to the digital content based on the container meta data fetched at step S264, and checks whether the digital content has actually been updated based on the digital content data per se or attribute information thereon (step S265). When the digital content is determined to have actually been updated, the index manager 107 requests the index storage unit 108 to update the index of the updated digital content (step S266). Upon receipt of the request, the index storage unit 108 updates the index (step S267), and transmits a result of the update to the index manager 107 (step S268).

The index manager 107 determines whether another digital content of which index is to be updated exists (step S269). When no more digital content of which index is to be updated exists, processing proceeds to step S270. On the other hand, when another digital content of which index is to be updated exists, processing proceeds to step S264. Through the processes pertaining to steps S264 to S269, the container is browsed.

At step S270, the index manager 107 determines whether the index update is completed. When the index update is completed, the (second) index update ends, while, when the index update is not completed, processing proceeds to step S261.

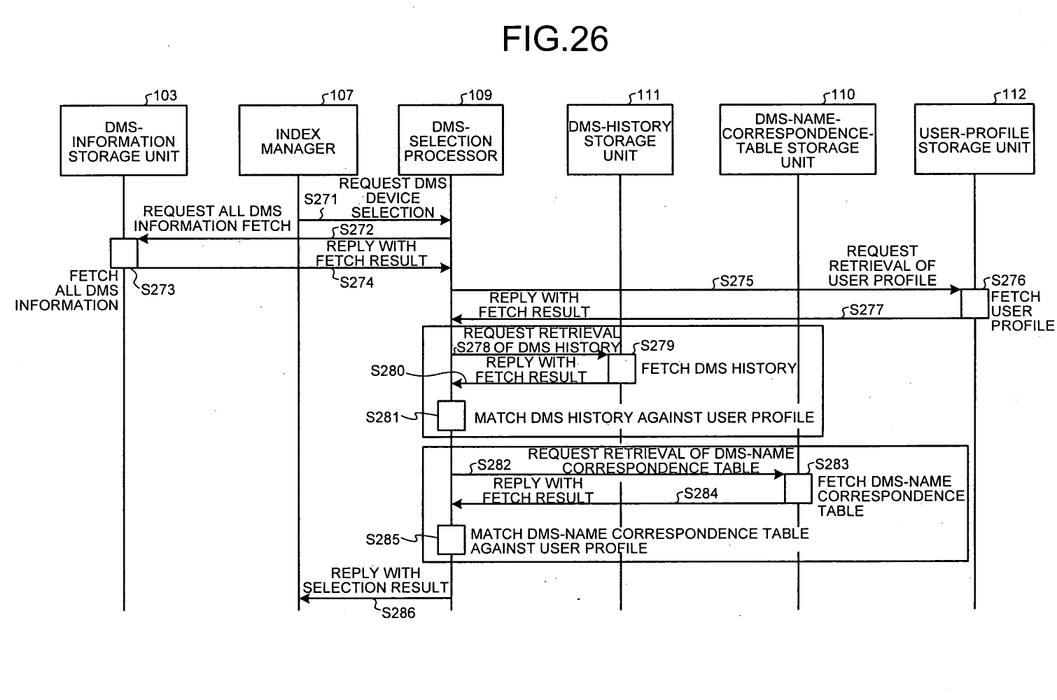

Processes pertaining to steps S216 to S218 of FIG. 22 for selecting the DMS device 300 will be described in detail below. FIG. 26 is a time chart of the processes. As shown in FIG. 26, first, the index manager 107 of the digital-content retrieval apparatus 100 transmits a request to the DMS information manager 109 to select one of the DMS devices 300 (step S271). Upon receipt of the request, the DMS-selection processor 109 refers to the DMS-information storage unit 103 to fetch the DMS information on all the DMS devices 300 (step S272). In response to the reference, the DMS-information storage unit 103 fetches the DMS information on all the DMS devices 300 (step S273), and transmits a result of the fetch to the DMS-selection processor 109 (step S274).

The DMS-selection processor 109 refers to the user-profile storage unit 112 to fetch user profile information (step S275). In response to the reference, the user-profile storage unit 112 fetches the user profile information (step S276), and transmits a result of the fetch to the DMS-selection processor 109 (step S277).

The DMS-selection processor 109 refers to the DMS-history storage unit 111 to fetch DMS history information (step S278). In response to the reference, the DMS-information storage unit 111 fetches the DMS history information (step S279), and transmits a result of the fetch to the DMS-selection processor 109 (step S280). The DMS-selection processor 109 matches the DMS history against the user profile (step S281). By performing processes pertaining to step S278 to S281, the DMS device 300 frequently used by the user is identified. Hence, the DMS device 300 that should be assigned higher priority is determined based on the digital content frequently used by the user, thereby allowing to preferentially index the DMS device 300 to which the higher priority is assigned.

The DMS-selection processor 109 refers to the DMS-name-correspondence-table storage unit 110 to fetch DMS-name correspondence information (step S282). In response to the reference, the DMS-information storage unit 110 fetches the DMS-name correspondence information (step S283), and transmits a result of the fetch to the DMS-selection processor 109 (step S284). The DMS-selection processor 109 matches the DMS-name correspondence table against the user profile (step S285). By performing the processes pertaining to step S282 to S285, classes and categories of digital contents held by each of the DMS device 300 are identified. Hence, the DMS device 300 that should be assigned higher priority is determined based on the digital contents that belong to the class and category frequently used by the user, thereby allowing to preferentially index the DMS device 300 to which the higher priority is assigned.

Performing either one of a series of processes pertaining to steps S278 to S281 and that pertaining to steps S282 to S285 is sufficient, and performing the both is not requisite.

The DMS-selection processor 109 transmits a result of the DMS device 300 selection made at step S281 or S285 to the index manager 107 (step S286).

As a method of determining the class of a content held by the DMS device 300 to thus determine priority of the DMS device 300 to be indexed, determining the class based on the DMS history information has been described through steps S278 to 280. However, the method is not limited thereto, and, alternatively, using a determining server that determines the class of the DMS device, using a search engine on the Internet, and the like, can be employed.

By performing the processes to select the DMS device 300, index creation is attained while assigning higher priorities to the DMS devices 300 that hold the frequently-used digital contents. For example, when a class of contents held by the DMS devices 300 is determined based on the name of the DMS device (Device Name), and higher priorities are assigned to the DMS devices 300 that hold frequently-used contents in index creation, index creation can be attained efficiently. Furthermore, because this method allows to create indexes by a content class, when one of the DMS devices 300 holds the digital contents all of which belonging to a specific content class, index creation for the DMS device 300 can be attained more efficiently and speedily.

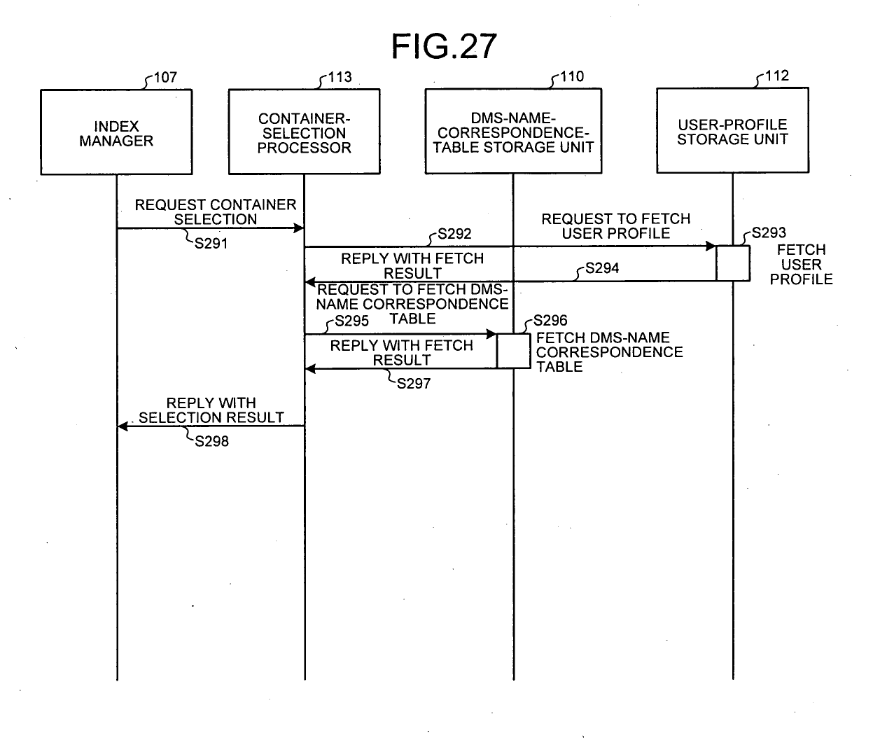

Processes pertaining to steps S213 to S215 of FIG. 22 of selecting a container will be described in detail below. FIG. 27 is a time chart of the processes. As shown in FIG. 27, first, the index manager 107 of the digital-content retrieval apparatus 100 transmits a request to the container-selection processor 113 to select a container (step S291). Upon receipt of the request, the container-selection processor 113 refers to the user-profile storage unit 112 to fetch user profile information (step S292). In response to the reference, the user-profile storage unit 112 fetches the user profile information (step S293), and transmits a result of the fetch to the container-selection processor 113 (step S294).

The container-selection processor 113 refers to the DMS-name-correspondence-table storage unit 110 to fetch DMS-name correspondence information (step S295). In response to the reference, the DMS-name correspondence-table storage unit 110 fetches the DMS-name correspondence information (step S296), and transmits a result of the fetch to the container-selection processor 113 (step S297). Upon receipt of a result of the fetch, the container-selection processor 113 selects the container corresponding to the class, to which the digital content frequently used by the user belongs, based on the fetched DMS-name correspondence table information.

The container-selection processor 113 transmits a result of the selection to the index manager 107 (step S298). By performing the processes pertaining to step S278 to S281, the container, to which the digital content frequently used by the user belongs, is identified. Hence, indexing can be attained while assigning higher priority to the container or a content class, to which the digital contents frequently used by the user belongs.

According to this method, the digital-content retrieval apparatus 100 creates indexes while assigning higher priority to frequently-used contents. When one or more of the DMS devices 300 have the “sufficient search capability”, a retrieval request is supplied to each DMS device 300 with designation of the “content class” (upnp:class) so that a digital content of the content class frequently used by the user is searched for. On the other hand, with regard to the DMS device 300 not having the “sufficient search capability”, containers with a content name (dc:title), which is specified to be of the frequently-used content class, are preferentially browsed using the browsing request. For example, to the DMS device 300 having the “sufficient search capability”, a retrieval request is issued with designation of the “moving images” as the content class, whereas, to the DMS devices 300 not having the “sufficient search capability”, a browsing request is issued with designation of the “moving images” as the containers. This allows to create indexes efficiently and speedily when contents are classified by content class.

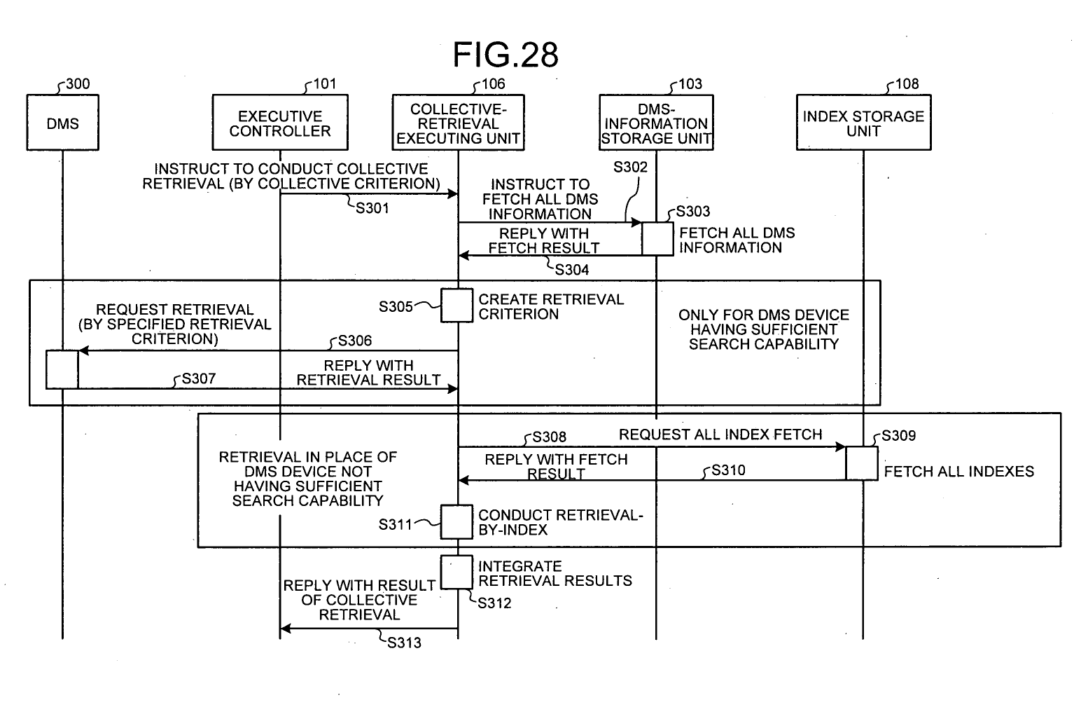

Collective retrieval shown in FIG. 19 performed by the digital-content retrieval apparatus 100 will be described in detail below. FIG. 28 is a time chart of the collective retrieval performed by the digital-content-retrieval apparatus 100. As shown in FIG. 28, first, the executive controller 101 of the digital-content retrieval apparatus 100 transmits an instruction to perform collective retrieval to the collective-retrieval executing unit 106 with designation of a collective retrieval criterion (step S301).

The collective-retrieval executing unit 106 transmits an instruction to the DMS-information storage unit 103 to fetch the DMS information on all the DMS devices 300 (step S302). Upon receipt of the instruction, the DMS-information storage unit 103 fetches the DMS information on all the DMS devices 300 (step S303), and transmits a result of the fetch to the collective-retrieval executing unit 106 (step S304).

The collective-retrieval executing unit 106 creates a retrieval criterion based on designation of the user, the user profile information, the DMS history, and the like (step S305). The collective-retrieval executing unit 106 requests the DMS device 300 to conduct retrieval by specifying the retrieval criterion created at step S305 (step S306). The DMS device 300 transmits a result of the retrieval conducted by the device 300 in response to the request to the collective-retrieval executing unit 106 (step S307). The processes pertaining to steps S305 to S307 are to be conducted against the DMS devices 300 determined to have the sufficient search capability.

Meanwhile, the collective-retrieval executing unit 106 transmits a request to the index storage unit 108 to fetch indexes on all the DMS devices 300 (step S308). Upon receipt of the request, the index storage unit 108 retrieves the indexes on all the DMS devices 300 (step S309), and transmits a result of the fetch to the collective-retrieval executing unit 106 (step S310). The collective-retrieval executing unit 106 conducts retrieval, in place of the DMS device 300 not having the sufficient search capability, from the digital contents held by the DMS device 300 using the fetched indexes (step 8311). The processes pertaining to steps S308 to S311 are to be conducted against the DMS devices 300 determined not to have the sufficient search capability.

The collective-retrieval executing unit 106 controls the collective-retrieval-result display controller 116 to integrate a result of digital content retrieval conducted at steps S306 and S307 from the DMS devices 300 having the sufficient search capability, and a digital content retrieval conducted at step S311 from the DMS device 300 not having the sufficient search capability so that the results are displayed in a single list (step S312). The collective-retrieval executing unit 106 transmits the thus-integrated retrieval result to the executive controller 101 (step S313).

While embodiments of the present invention have been explained above, the invention is not limited thereto, and can be implemented in various embodiments within the scope of the invention as set forth in the appended claims. Effects of the present invention are not limited to those explained in the embodiments.

According to the embodiments described above, determination as to whether the DMS device has the “sufficient search capability” is employed as a criterion for selecting the retrieval method for the DMS device. However, the criterion for selecting the retrieval method for the DMS device is not limited thereto. Examples of an alternative criterion include: a processing speed of control means, such as a CPU, of the DMS device; a memory capacity of the DMS device; whether the DMS device is battery-powered, and, when the DMS device is battery-powered, the amount of the remaining battery capacity; a network-communication speed of the DMS device; a status of load, such as CPU usage, applied by the DMS device on the control means; the total amount of digital contents held by the DMS device; usage frequency of digital contents held by the DMS device; and a degree of coincidence between an attribute (content class, title, artist, and the like) of digital contents held by the DMS device and preferences of the user. When a DMS device is determined to be low in performance or to have a heavy processing load based on any one or an arbitrary combination of the criteria, or when a DMS device is expected to receive a load based on a usage pattern of its user, creating indexes for enabling quick retrieval can yield a greater effect. In other words, determination as to whether a DMS device has “sufficient search capability” can be made as follows: when the DMS device is determined to be low in performance or to have a heavy processing load, or when the DMS device is expected to receive a load based on a usage pattern of its user, the DMS device is determined not to have the “sufficient search capability”, while, when the DMS device is determined not to be low in performance or not to have a heavy processing load, or when the DMS device is not expected to receive a load based on a usage pattern of its user, the DMS device is determined to have the “sufficient search capability”.

According to the embodiments, the device not having the sufficient search capability is indexed without fail. Alternatively, when the DMS device has sufficient processing capability and responsivity, retrieval of a digital content can be conducted using the browsing function of the DMS device. In other words, when a DMS device is determined to have the sufficient search capability, retrieval is conducted using the retrieval function of the DMS device, whereas when the DMS device is determined not to have the capability, retrieval is conducted using the browsing function of the DMS device. When a DMS device is determined not to have the sufficient search capability but have a sufficient processing and responsivity, retrieval of a digital content is conducted using the browsing function of the DMS device. Which DMS device and container should be prioritized in using the browsing function can be determined by the similar method as that employed in the index creation described above. Meanwhile, when a DMS device is determined to have neither the sufficient search capability nor the sufficient processing and responsivity, retrieval of a digital content can be conducted by creating indexes.

Among the respective processes explained in the embodiments, all or a part of the processes explained as being performed automatically can be performed manually, or all or a part of the processes explained as being performed manually can be performed automatically by a known method. Information including the process procedures, control procedures, specific names, and various kinds of data and parameters shown in the embodiments can be optionally changed, unless otherwise specified.

The respective constituent elements of each apparatus shown in the drawings are functionally conceptual, and physically the same configuration is not always necessary. In other words, the specific mode of dispersion and integration of each apparatus is not limited to the ones in the drawings, and all or a part thereof can be functionally or physically dispersed or integrated in an optional unit, according to the various kinds of load and the status of use.

All or an optional part of various process functions performed by each apparatus can be realized by a CPU (or a micro computer such as a micro processing unit (MPU) or a micro controller unit (MCU)) or a program analyzed and executed by the CPU (or the micro computer such as an MPU or an MCU), or can be realized as hardware by the wired logic.

According to an aspect of the present invention, to a digital-content storage device having the search capability, a request to conduct retrieval using the retrieval function provided in the digital-content storage device is issued, whereas, to a digital-content storage device not having a search capability, fetching content information on digital contents by using the browsing function of the digital-content storage device is conducted or retrieval-by-index is conducted in place of retrieval performed by the digital-content storage device. Hence, collective retrieval can be conducted irrespective of whether the digital-content storage device has the search capability. In addition, by relegating browsing to a digital-content storage device that does not have the search capability but has a sufficient processing capability and responsivity, quicker retrieval is attained.

According to another aspect of the present invention, because results of the collective retrieval can be displayed in a single list, collective retrieval from both a digital-content storage device not having the search capability and a digital-content storage device having the search capability can be conducted in the completely same manner without concerning whether each digital-content storage device has the search capability.

According to still another aspect of the present invention, because indexes are created based on a profile that records a user's usage history on a digital content, prioritized search attributes, and the like on a user-by-user basis, indexes of digital contents that belong to a class frequently used by the user can be created preferentially.

According to still another aspect of the present invention, to a digital-content storage device having the search capability, a request to retrieve a digital content using the retrieval function provided in the digital-content storage device is issued, whereas retrieval using indexes is performed only to a digital-content storage device not having the search capability nor a sufficient processing capability and responsivity. Hence, efficient index creation can be attained.

According to still another aspect of the present invention, content information on digital contents held by an indexed digital-content storage device is stored as a history. Hence, browsing or index creation can be performed while assigning higher priority to a digital-content storage device that has already been browsed or indexed.

According to still another aspect of the present invention, indexes are created while assigning higher priority to a digital-content storage device that has been selected based on a history stored at history storing and a profile stored at profile storing. Hence, a digital-content storage device that holds a frequently-used digital content can be indexed or browsed with higher priority.

Although the invention has been described with respect to a specific embodiment for a complete and clear disclosure, the appended claims are not to be thus limited but are to be construed as embodying all modifications and alternative constructions that may occur to one skilled in the art that fairly fall within the basic teaching herein set forth.

What is claimed is:

1. A computer-readable recording medium that stores therein a computer program that causes a computer to execute a digital-content retrieval procedure for collectively retrieving a digital content satisfying a specified retrieval criterion from a plurality of digital-content storage devices connected to a network, the computer program causing the computer to execute:
determining whether each of the digital-content storage devices has a search capability; and
collective retrieving including
when one or more of the digital-content storage devices are determined to have the search capability at the determining, requesting each of the devices to retrieve the digital content using a retrieval function provided in the digital-content storage device, and
when one or more of the digital-content storage devices are determined not to have the search capability at the determining, fetching content information on a digital content stored in each of the devices using a browsing function provided in the digital-content storage device.

2. A computer-readable recording medium that stores therein a computer program that causes a computer to execute a digital-content retrieval procedure for collectively retrieving a digital content satisfying a specified retrieval criterion from a plurality of digital-content storage devices connected to a network, the computer program causing the computer to execute:
determining whether each of the digital-content storage devices has a search capability;
creating and storing an index of a digital content stored in each of the devices when one or more of the digital digital-content storage devices determined not to have the search capability at the determining; and
collective retrieving including
when one or more of the digital-content storage devices are determined to have the search capability at the determining, requesting each of the devices to retrieve the digital content using a retrieval function provided in the digital-content storage device, and
retrieving, from each of the digital-content storage devices determined not to have the search capability at the determining, the digital content by utilizing the index created at the creating and storing.

3. The computer-readable recording medium according to claim 2, wherein the computer program further causing the computer to execute integrating a result of the retrieval requested to and conducted by each of the digital-content storage devices determined to have the search capability at the determining, and a result of the retrieval utilizing the index conducted by each of the digital-content storage devices determined not to have the search capability at the determining, the results obtained by the collective retrieving, to be displayed in a single list.

4. The computer-readable recording medium according to claim 2, wherein the computer program further causing the computer to execute profile storing of storing content information on a user-by-user basis as a profile, wherein the content information is information on a digital content read and reproduced from each of the digital-content storage devices connected to the network, wherein
the creating and storing includes creating the index according to priority determined based on the profile stored at the profile storing.

5. The computer-readable recording medium according to claim 2, wherein the computer program further causing the computer to execute search-capability storing of storing the search capability determined at the determining for each of the digital-content storage devices, wherein
the collective retrieving includes either one of requesting the digital-content storage devices to conduct retrieval according to the search capabilities stored at the search-capability storing, and retrieving the digital content using the index.

6. The computer-readable recording medium according to claim 4, wherein the computer program further causing the computer to execute history storing of storing content information on a digital content held by the digital-content storage device, of which index has been created at the creating and storing, as a history.

7. The computer-readable recording medium according to claim 6, wherein the creating and storing includes preferentially creating an index of one of the digital-content storage devices selected based on the history stored at the history storing and the profile stored at the profile storing.

8. The computer-readable recording medium according to claim 2, wherein the creating and storing includes storing content information on a digital content of each of the digital-content storage devices of which indexes have been created.

9. A digital-content retrieval apparatus that collectively retrieves a digital content satisfying a specified retrieval criterion from a plurality of digital-content storage devices connected to a network, the digital-content retrieval apparatus comprising:
a search-capability determining unit that determines whether each of the digital-content storage devices has a search capability; and
a collective-retrieval executing unit that
when one or more of the digital-content storage devices are determined to have the search capability by the search-capability determining unit, requests each of the devices to retrieve the digital content using a retrieval function provided in the digital-content storage device, and
when one or more of the digital-content storage devices are determined not to have the search capability by the search-capability determining unit, fetches content information on a digital content stored in each of the devices using a browsing function provided in the digital-content storage device.

10. A digital-content retrieval apparatus that collectively retrieves a digital content satisfying a specified retrieval criterion from a plurality of digital-content storage devices connected to a network, the digital-content retrieval apparatus comprising:
a search-capability determining unit that determines whether each of the digital-content storage devices has a search capability;
a creating-and-storing unit that creates and stores an index of a digital content stored in each of the devices when one or more of the digital digital-content storage devices determined not to have the search capability by the search-capability determining unit; and
a collective-retrieval executing unit that
when one or more of the digital-content storage devices are determined to have the search capability by the search-capability determining unit, requests each of the devices to retrieve the digital content using a retrieval function provided in the digital-content storage device, and
retrieves, from each of the digital-content storage devices determined not to have the search capability by the search-capability determining unit, the digital content by utilizing the index created by the creating-and-storing unit.

11. The digital-content retrieval apparatus according to claim 10, further comprising a retrieval-result integrating unit that integrates a result of the retrieval requested to and conducted by each of the digital-content storage devices determined to have the search capability by the search-capability determining unit, and a result of the retrieval utilizing the index conducted by each of the digital-content storage devices determined not to have the search capability by the search-capability determining unit, the results obtained by the collective-retrieval executing unit, to be displayed in a single list.

12. The digital-content retrieval apparatus according to claim 10, further comprising a profile storage unit that stores therein content information on a user-by-user basis as a profile, wherein the content information is information on a digital content read and reproduced from each of the digital-content storage devices connected to the network, wherein
the creating-and-storing unit creates the index according to priority determined based on the profile stored in the profile storage unit.

13. The digital-content retrieval apparatus according to claim 10, further comprising a search-capability storage unit that stores therein the search capability determined by the search-capability determining unit for each of the digital-content storage devices, wherein
the collective-retrieval executing unit executes either one of requesting the digital-content storage devices to conduct retrieval according to the search capabilities stored in the search-capability storage unit, and retrieving the digital content using the index.

14. The digital-content retrieval apparatus according to claim 12, further comprising a history storage unit that stores therein content information on a digital content held by the digital-content storage device, of which index has been created by the creating-and-storing unit, as a history.

15. The digital-content retrieval apparatus according to claim 14, wherein the creating-and-storing unit preferentially creates an index of one of the digital-content storage devices selected based on the history stored in the history storage unit and the profile stored in the profile storage unit.

16. The digital-content retrieval apparatus according to claim 10, wherein the creating-and-storing unit stores therein content information on a digital content of each of the digital-content storage devices of which indexes have been created.

17. A digital-content retrieval method for collectively retrieving a digital content satisfying a specified retrieval criterion from a plurality of digital-content storage devices connected to a network, the digital-content retrieval method comprising:
determining whether each of the digital-content storage devices has a search capability; and
collective retrieving including
when one or more of the digital-content storage devices are determined to have the search capability at the determining, requesting each of the devices to retrieve the digital content using a retrieval function provided in the digital-content storage device, and
when one or more of the digital-content storage devices are determined not to have the search capability at the determining, fetching content information on a digital content stored in each of the devices using a browsing function provided in the digital-content storage device.

18. A digital-content retrieval method for collectively retrieving a digital content satisfying a specified retrieval criterion from a plurality of digital-content storage devices connected to a network, the digital-content retrieval method comprising:
determining whether each of the digital-content storage devices has a search capability;
creating and storing an index of a digital content stored in each of the devices when one or more of the digital digital-content storage devices determined not to have the search capability at the determining; and
collective retrieving including
when one or more of the digital-content storage devices are determined to have the search capability at the determining, requesting each of the devices to retrieve the digital content using a retrieval function provided in the digital-content storage device, and
retrieving, from each of the digital-content storage devices determined not to have the search capability at the determining, the digital content by utilizing the index created at the creating and storing.

19. The digital-content retrieval method according to claim 18, further comprising integrating a result of the retrieval requested to and conducted by each of the digital-content storage devices determined to have the search capability at the determining, and a result of the retrieval utilizing the index conducted by each of the digital-content storage devices determined not to have the search capability at the determining, the results obtained by the collective retrieving, to be displayed in a single list.

20. The digital-content retrieval method according to claim 18, further comprising profile storing of storing content information on a user-by-user basis as a profile, wherein the content information is information on a digital content read and reproduced from each of the digital-content storage devices connected to the network, wherein
the creating and storing includes creating the index according to priority determined based on the profile stored at the profile storing.

21. The digital-content retrieval method according to claim 18, further comprising search-capability storing of storing the search capability determined at the determining for each of the digital-content storage devices, wherein
the collective retrieving includes either one of requesting the digital-content storage devices to conduct retrieval according to the search capabilities stored at the search-capability storing, and retrieving the digital content using the index.

22. The digital-content retrieval method according to claim 20, further comprising history storing of storing content information on a digital content held by the digital-content storage device, of which index has been created at the creating and storing, as a history.

23. The digital-content retrieval method according to claim 22, wherein the creating and storing includes preferentially creating an index of one of the digital-content storage devices selected based on the history stored at the history storing and the profile stored at the profile storing.

24. The digital-content retrieval method according to claim 18, wherein the creating and storing includes storing content information on a digital content of each of the digital-content storage devices of which indexes have been created.
